(19) United States
(12) Patent Application Publication
(10) Pub. No.: US 2007/0110056 A1
(43) Pub. Date: May 17, 2007

(54) Apparatus and method for delivering service guide contents and notification event information in a mobile broadcast system

(76) Inventors: Sung-Oh Hwang, Yongin-si (KR); Jae-Kwon Oh, Seoul (KR); Jong-Hyo Lee, Pyeongtaek-si (KR); Kook-Heui Lee, Yongin-si (KR); Byung-Rae Lee, Yongin-si (KR); Jae-Yong Lee, Seoul (KR); Bo-Sun Jung, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/593,643

(22) Filed: Nov. 7, 2006

(30) Foreign Application Priority Data
Nov. 7, 2005 (KR) 10-2005-0106215
Mar. 3, 2006 (KR) 10-2006-0020677

(51) Int. Cl. H04L 12/56

(52) U.S. Cl. 370/389; 709/231

(57) ABSTRACT

A system and method is provided for providing a service guide for a mobile broadcast (BCAST) service in a wireless communication/broadcast system supporting the BCAST service. If there is a need to provide a service guide in the mobile broadcast system, a Service Guide Subscription Source (SGSS) delivers a subscription and provisioning source, and a purchase and promotional source, to a BCAST Service Distribution/Adaptation block. The BCAST Service Distribution/Adaptation block then generates and provides a service guide using the sources.

### CROSS-REFERENCE TO RELATED APPLICATIONS

This application claims the benefit under 35 U.S.C. §119(a) of Korean Patent Application No. 10-2005-0106215, entitled “Apparatus and Method for Delivering Service Guide Contents and Notification Event Information in a Mobile Broadcast System” filed Nov. 7, 2005 in the Korean Intellectual Property Office, and Korean Patent Application No. 10-2006-0020677, entitled “Apparatus and Method for Delivering Service Guide Contents and Notification Event Information in a Mobile Broadcast System” filed Mar. 3, 2006 in the Korean Intellectual Property Office, the entire disclosures of both of which are hereby incorporated by reference.

### BACKGROUND OF THE INVENTION

1. Field of the Invention

The present invention relates generally to an apparatus and method for transmitting a message supporting Broadcast Service (BCAST). In particular, the present invention relates to an apparatus and method for delivering a notification message including information indicating a change in system and service.

2. Description of the Related Art

Today, with the development of communication and broadcast technologies, broadcast systems and mobile communication systems have evolved into systems that are capable of providing mobile broadcast services. There are ongoing discussions on mobile broadcast systems that are capable of transmitting packet data as well as conventional audio/video broadcast services, over a broadcast channel.

The term “mobile broadcast” refers to technologies for providing broadcast services through mobile terminals that are capable of receiving the mobile broadcast, such as mobile phones, notebook computers, and Personal Digital Assistants (PDA). In order to receive the broadcast service, the mobile terminal should first be able to discover the provided service, and a subscriber of the mobile terminal should subscribe to the broadcast service so that he/she can receive the provided service. In addition, in order to receive the broadcast service, the mobile terminal should receive a variety of control information provided from the broadcast system. Further, the system supporting the broadcast service should transmit service data. If the broadcast service and variety of information associated therewith are provided, the mobile terminal receives service control information and broadcast service data. In this manner, the user can view the broadcast.

The Open Mobile Alliance (OMA), a group studying standards for interworking between individual mobile solutions, mainly directs the establishment of various application standards for mobile games, Internet services, and so forth. Among OMA working groups, the OMA Browser and Content (BAC) Mobile Broadcast Sub Working Group (BCAST) studies technologies for providing broadcast services using mobile terminals.

In the mobile broadcast system under discussion in the OMA, a mobile terminal for receiving broadcast service receives service guide (SG) information including service description information, service charging information and service reception method information, and receives the corresponding service using the service guide information.

However, one or more parts of the service guide information can vary at anytime. Therefore, every time a particular service changes for example, a service guide for the corresponding service should be repeatedly transmitted. In addition, mobile broadcast is characterized in that in consideration of the advent of a new mobile terminal, a service guide for the mobile broadcast service is repeatedly transmitted even though there is no change in the service guide. The advent of a new mobile terminal refers to the presence of a new mobile terminal that has not previously received the service, but now receives the service. For example, if there is a new user desiring to receive broadcast service by turning on power of the mobile terminal, or if there is a mobile terminal that should receive a new service guide due to movement of its user, the new mobile terminal should receive the service guide independently of the mobile terminals that have already been receiving the mobile broadcast.

In the mobile broadcast system, it is very important to reliably deliver and respond to the service guide information. Therefore, a need exists for a system and method for delivering content information and notification event information based on which a content provider generates a BCAST service guide, determining information elements and attributes necessary for generating the associated messages, and sending a response indicating whether to perform the requirements.

### SUMMARY OF THE INVENTION

Accordingly, embodiments of the present invention are provided to substantially solve at least the above problems and/or disadvantages and provide at least the advantages described below. Embodiments of the present invention provide an apparatus and method for delivering content information and a notification event for the generation of a service guide in a mobile broadcast system.

Embodiments of the present invention provide an apparatus and method for reliably transmitting service guide information in a mobile broadcast system.

Embodiments of the present invention also provide an apparatus and method for receiving service guide information and transmitting a response signal thereto in a mobile broadcast system.

Embodiments of the present invention still further provide an apparatus and method for generating a message necessary for the transmission of service guide information in a mobile broadcast system.

Embodiments of the present invention still further provide an apparatus and method for determining an information element necessary for the generation of messages associated with the delivery of the service guide and notification event.

Embodiments of the present invention still further provide an apparatus and method for transmitting a response to the received service guide and notification event.

According to one aspect of embodiments of the present invention, a method for providing a service guide for a mobile broadcast (BCAST) service in a wireless communication/broadcast system supporting the BCAST service is provided, comprising the steps of determining a need to provide a service guide in the mobile broadcast system and if there is a need to provide a service guide in the mobile broadcast system, controlling a Service Guide Subscription Source (SGSS) to deliver a subscription and provisioning source, and a purchase and promotional source, to a BCAST Service Distribution/Adaptation block, and controlling the BCAST Service Distribution/Adaptation block to generate and provide a service guide using the sources.

According to another aspect of embodiments of the present invention, a system for providing a service guide for a mobile broadcast (BCAST) service in a wireless communication/broadcast system supporting the BCAST service is provided, comprising a Service Guide Subscription Source (SGSS) for delivering a subscription and provisioning source, and a purchase and promotional source, to a BCAST Service Distribution/Adaptation block, and the BCAST Service Distribution/Adaptation block for generating a service guide using the sources and providing the service guide to subscribers.

According to another aspect of embodiments of the present invention, a method for providing a notification message for a mobile broadcast (BCAST) service in a wireless communication/broadcast system supporting the BCAST service is provided, comprising the steps of determining, by a Notification Generation function (NTG) in a BCAST Subscription Management (BSM) block, whether a notification event notice occurs requesting the generation of a notification message and upon detecting the notification event, providing the NTG for generating a notification message according to the notification event and delivering the notification message to a Notification Distribution Adaptation function (NTDA) in a BCAST Service Distribution/Adaptation (BSD/A) block, thereby providing the notification message to subscribers.

According to yet another aspect of embodiments of the present invention, a system for providing a notification message for a mobile broadcast (BCAST) service in a wireless communication/broadcast system supporting the BCAST service is provided, comprising a Notification Event Function (NTE) for detecting the occurrence of a change in the service provided to a user from a BCAST Service Application (BSA) supporting the BCAST service and providing a notification event notice for noticing the occurrence, and a Notification Generation function (NTG) in a BCAST Subscription Management (BSM) block for, upon receipt of the notification event notice, generating a notification message and transmitting the notification message to a subscriber.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a block diagram illustrating exemplary architecture of a mobile broadcast system that can deliver a service guide to a mobile terminal according to an embodiment of the present invention;

FIG. 2 is a block diagram illustrating exemplary structures of notification interfaces, as defined in OMA BCAST, for providing notification messages in a mobile broadcast system according to an embodiment of the present invention;

FIG. 3 is a signaling diagram illustrating an exemplary message flow between logical entities for providing a service guide in a mobile broadcast system according to an embodiment of the present invention;

FIG. 4 is a signaling diagram illustrating an exemplary message flow between logical entities for providing a notification message in a mobile broadcast system according to an embodiment of the present invention;

FIG. 5 is a block diagram illustrating an exemplary data model for a service guide for generating a service guide in OMA BCAST according to an embodiment of the present invention;

FIG. 6 is a block diagram illustrating an exemplary protocol stack that can be used for transmitting a notification event in an NT-3 interface according to an embodiment of the present invention;

FIG. 7 is a signaling diagram illustrating an exemplary process of transmitting a message over an NT-3 interface in OMA BCAST according to an embodiment of the present invention;

FIG. 8 is a block diagram illustrating exemplary BCAST architecture proposed in OMA BCAST, for receiving Provisioning generation-related information according to an embodiment of the present invention;

FIG. 9 is an exemplary message flow diagram of FIG. 8;

FIG. 10 is a block diagram illustrating an exemplary transmission protocol stack of SG-3 in OMA BCAST according to an embodiment of the present invention;

FIG. 11 is a signaling diagram illustrating exemplary message delivery over SG-3 in OMA BCAST according to an embodiment of the present invention;

FIG. 12 is a block diagram illustrating an exemplary protocol stack used for delivering a request message for provisioning of a service guide source or a notification event over a backend interface of SG-3 or NT-3 according to an embodiment of the present invention;

FIG. 13 is a signaling diagram illustrating exemplary service guide source delivery between an SGAS and an SGSS over an SG-3 according to an embodiment of the present invention; and

FIG. 14 is a signaling diagram illustrating exemplary notification event delivery between an NTE and NTG over an NT-3 according to an embodiment of the present invention.

Throughout the drawings, like reference numerals will be understood to refer to like parts, components and structures.

### DETAILED DESCRIPTION OF EXEMPLARY EMBODIMENTS

Embodiments of the present invention will now be described in detail with reference to the annexed drawings. In the following description, a detailed description of known functions and configurations incorporated herein has been omitted for clarity and conciseness.

In the following detailed description, exemplary embodiments of the present invention are illustrated and described for achieving the above and other objects. Although names of the entities defined in the 3rd Generation Partnership Project (3GPP) which is the asynchronous mobile communication standard, or BCAST of the Open Mobile Alliance (OMA) which is the application standard for mobile terminals will be used for convenience, the standards and names are not intended to limit the scope of embodiments of the present invention, and the present invention can be applied to any number of systems having the same or similar technical backgrounds. A detailed description of embodiments of the present invention will now be made with reference to OMA BCAST, which is one of several mobile broadcast standards, but embodiments of the present invention are not limited thereto.

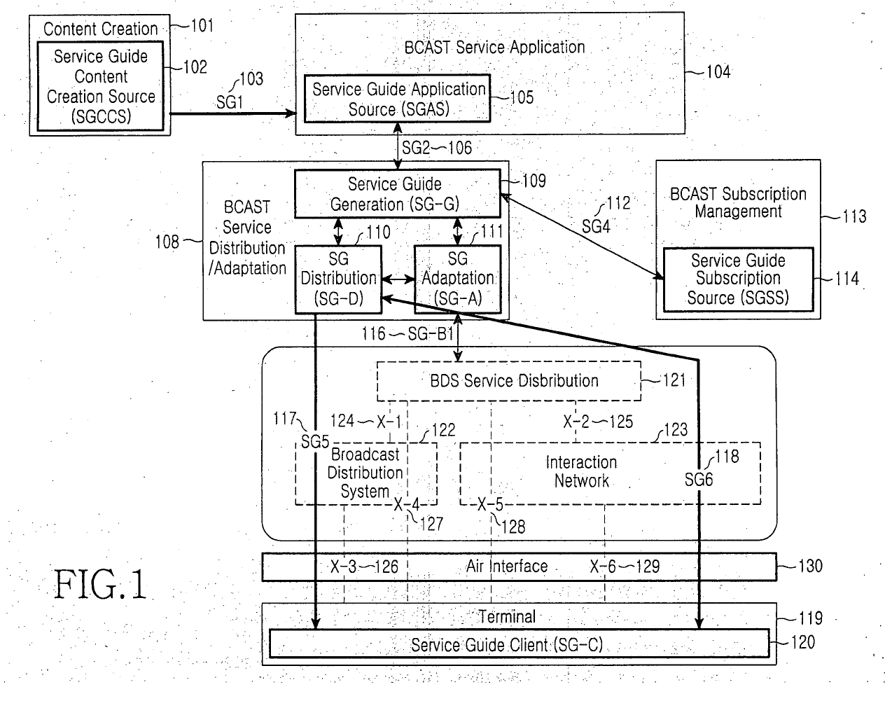

FIG. 1 is a block diagram illustrating exemplary architecture of a mobile broadcast system that can deliver a service guide to a mobile terminal according to an embodiment of the present invention. Table 1 and Table 2 below show by way of example, the interfaces used between elements (logical entities) of FIG. 1.

TABLE 1

| Name | Description |
|---|---|
| SG1 (103) | Server-to-server communications for delivering content attributes such as description |
| | information, location information, target terminal capabilities, target user profile, and so |
| | forth, either in the form of BCAST service guide fragments, or in a proprietary format. |
| SG2 (106) | Server-to-server communications for delivering BCAST service attributes such as |
| | service/content description information, scheduling information, location information, |
| | target terminal capabilities, target user profile, and so forth, in the form of BCAST service |
| | guide fragments. |
| SG-B1 (116) | Server-to-server communications for either delivering BDS specific attributes from BDS |
| | to BCAST Service Guide Adaptation function, to assist Service Guide adaptation to a |
| | specific BDS, or to deliver BCAST Service Guide attributes to BDS for BDS specific |
| | adaptation and distribution. |
| SG4 (112) | Server-to-server communications for delivering provisioning information, purchase |
| | information, subscription information, promotional information, and so forth, in the form |
| | of BCAST service guide fragments. |
| SG5 (117) | Delivery of BCAST Service Guide through Broadcast Channel, over IP. |
| SG6 (118) | Delivery of BCAST Service Guide through Interaction Channel. Interactive access to |
| | retrieve Service Guide or additional information related to Service Guide, for example, by |
| | HTTP, SMS, or MMS. |

TABLE 2

| Name | Description |
|---|---|
| X-1 (124) | Reference Point between BDS Service Distribution and BDS. |
| X-2 (125) | Reference Point between BDS Service Distribution and |
| | Interaction Network. |
| X-3 (126) | Reference Point between BDS and Terminal. |
| X-4 (127) | Reference Point between BDS Service Distribution and |
| | Terminal over Broadcast Channel. |
| X-5 (128) | Reference Point between BDS Service Distribution and |
| | Terminal over Interaction Channel. |
| X-6 (129) | Reference Point between Interaction Network and Terminal. |

Referring to FIG. 1, a Content Creation (CC, or content provider) block 101 is a provider of Broadcast Service (BCAST), and the BCAST service can include conventional audio/video broadcast service, music/data file download service, and so forth. The Content Creation block 101, using a Service Guide Content Creation Source (SGCCS) 102, delivers content information necessary for the creation of a BCAST service guide, capability information of mobile terminals, user profile, and content time information, to a Service Guide Application Source (SGAS) 105 in a BCAST Service Application (BSA) block 104 through the SG1 interface 103 of Table 1.

The BCAST Service Application block 104 processes data of the BCAST service provided from the Content Creation block 101 in the form appropriate for a BCAST network, thereby making BCAST service data. In addition, the BCAST Service Application block 104 generates standardized metadata that is necessary for the mobile broadcast guide. The SGAS 105 delivers various sources necessary for the generation of a service guide such as service/content information, scheduling information and location information, including the information provided from the SGCC 102, to a Service Guide Generation (SG-G) function 109 in a BCAST Service Distribution/Adaptation (BSD/A) block 108 through the SG2 interface 106.

The BCAST Service Distribution/Adaptation block 108 has a function of setting up a bearer over which it will transmit the BCAST service data provided from the BCAST Service Application block 104, a function of determining transmission scheduling of the BCAST service, and a function of creating mobile broadcast guide information. The BCAST Service Distribution/Adaptation block 108 is connected to a Broadcast Distribution System (BDS) 122, which is a network for transmitting BCAST service data, and an Interaction Network 123 supporting interactive communication.

The service guide generated by the SG-G 109 is delivered to a Terminal 119 via an SG Distribution (SG-D) function 110 and the SG5 interface 117. If the service guide is delivered via the BDS 122 or the Interaction Network 123 supporting interactive communication, or if there is a need for matching with the corresponding system or network, the service guide generated from the SG-G 109 is matched in an SG Adaptation (SG-A) function 111, and is then delivered via the SG-D 110 or delivered to a BDS Service Distribution block 121 via the SG-B1 interface 116.

A BCAST Subscription Management (BSM) block 113 manages subscription information and service provisioning information for receipt of BCAST service, and device information for a terminal receiving BCAST service. A Service Guide Subscription Source (SGSS) 114 in the BCAST Subscription Management block 113 delivers such source data as source and purchase information related to the generation of the service guide, subscription, provisioning, and promotional information, to the SG-G 109 that generates the service guide, via the SG4 interface 112.

The BDS Service Distribution block 121 serves to distribute all of the received BCAST services through a broadcast channel or an interaction channel, and is an entity that can exist or not exist according to the type of the BDS 122. The BDS 122 is a network that transmits BCAST service, and can be a broadcast network such as Digital Video Broadcasting-Handheld (DVB-H), 3GPP-based Multimedia Broadcast and Multicast Services (MBMS), and 3GPP2-based Broadcast and Multicast Services (BCMCS). The Interaction Network 123 transmits BCAST data on a point-to-point basis, or interactively exchanges control information and additional information related to the reception of the BCAST service, and can be, for example, an existing cellular network.

The Terminal 119 is a terminal that is capable of receiving the BCAST service, and can be connected to the cellular network according to terminal capability. The Terminal 119, including a Service Guide Client (SG-C) 120, receives the service guide transmitted via the SG5 interface 117 or receives a notification message transmitted via the SG6 interface 118, for example via the air interface 130, and thereby performing an appropriate operation for receiving the BCAST service.

Table 3 to Table 5 below provide by way of example, definitions of the functions of key elements (logical entities) shown in FIG. 1 in the OMA BCAST service standard.

TABLE 3

| Name | Description |
|---|---|
| Content | In Content Creation, Service Guide Content Creation Source (SGCCS) may provide |
| Creation (101) | contents and attributes such as content description information, target terminal |
| | capabilities, target user profile, content timing information, and so forth, and sends them |
| | over SG1 in the form of standardized BCAST Service Guide fragments, or in a |
| | proprietary format. |
| BCAST | In BCAST Service Application, Service Guide Application Source (SGAS) provides |
| Service | service/content description information, scheduling information, location information, |
| Application | target terminal capabilities, target user profile, and so forth, and sends them over SG2 in |
| (104) | the form of standardized BCAST Service Guide fragments. |
| BCAST | In BCAST Subscription Management, Service Guide Subscription Source (SGSS) |
| Subscription | provides provisioning information, purchase information, subscription information, |
| Management | promotional information, and so forth, and sends them over SG4 in the form of Service |
| (113) | Guide fragments. |

TABLE 4

| Name | Description |
|---|---|
| Service Guide | The Service Guide Generation (SG-G) in the network is responsible for receiving |
| Generation | Service Guide fragments from various sources such as SGCCS, SGAS, and SGSS over |
| (SG-G) (109) | SG-2 and SG-4 interfaces. SG-G assembles the fragments such as services and content |
| | access information, according to a standardized schema, and generates a Service Guide |
| | which is sent to Service Guide Distribution (SG-D) for transmission. Before |
| | transmission, it is optionally adapted in the Service Guide Adaptation Function (SG-A) |
| | 111 to suit a specific BDS. |
| Service Guide | The Service Guide Client Function (SG-C) in the terminal is responsible for receiving |
| Client | the Service Guide information from the underlying BDS, and making the Service Guide |
| Function (SG- | available to the mobile terminal. The SG-C obtains specific Service Guide information. |
| C) (120) | It may filter it to match the terminal specified criteria (for example, location, user |
| | profile, terminal capabilities and so forth), or it simply obtains all available Service |
| | Guide information. Commonly, the user may view the Service Guide information in a |
| | menu, list or tabular format. SG-C may send a request to the network through SG6 to |
| | obtain specific Service Guide information, or the whole Service Guide. |

TABLE 5

| Name | Description |
|---|---|
| Service Guide | SG-D generates an IP flow to transmit the Service Guide over the SG5 interface and the |
| Distribution | broadcast channel to the SG-C. Before transmission, the SG-G may send the Service |
| (SG-D) (110) | Guide to Service Guide Adaptation (SG-A) to adapt the Service Guide to suit a specific |
| | BDS, according to the BDS attributes sent by BDS Service Distribution over SG-B1. |
| | The adaptation might result in the modification of the Service Guide. Note that, for |
| | adaptation purpose, the SG-A may also send the BCAST Service Guide attributes or |
| | BCAST Service Guide fragments over SG-B1 to BDS Service Distribution for |
| | adaptation. This adaptation within BDS Service Distribution is beyond the scope of |
| | BCAST. SG-D may also receive a request for Service Guide information, and send the |
| | requested Service Guide information to the terminal directly through the interaction |
| | channel. SG-D also may filter Service Guide information from SG-G based on an End |
| | User's pre-specified profile. And SG-D may also send the Service Guide to the BDS, |
| | which modifies the Service Guide (e.g., by adding BDS specific information), and |
| | further distributes the Service Guide to the SG-C in a BDS specific manner. |

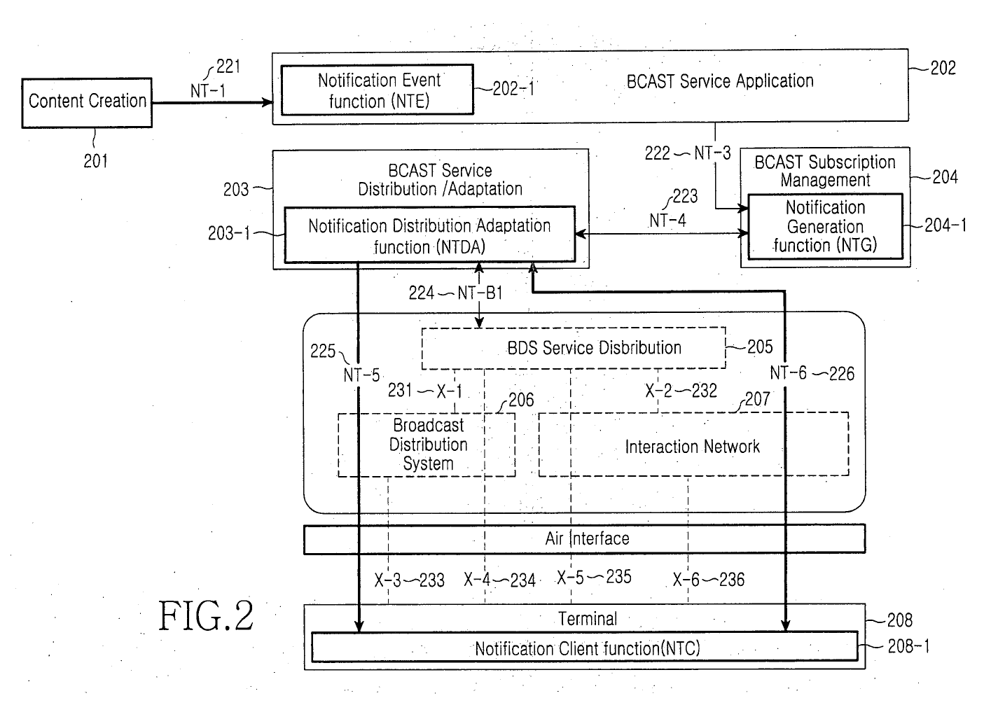

FIG. 2 is a block diagram illustrating exemplary structures of notification interfaces, as defined in OMA BCAST, for providing notification messages in a mobile broadcast system according to an embodiment of the present invention.

Referring to FIG. 2, a Content Creation (CC) block 201 is a provider of BCAST service, and the BCAST service can include conventional audio/video broadcast service, music/data file download service, and so forth. When there is a problem providing BCAST service or when there is a change in the BCAST service, the Content Creation block 201 notifies a Notification Event Function (NTE) 202-1 located in a BCAST Service Application (BSA) block 202 of the change.

The BCAST Service Application block 202 processes data of the BCAST service provided from the Content Creation block 201 in the form appropriate for a BCAST network, thereby making BCAST service data, and generates standardized metadata that is necessary for the mobile broadcast guide. In addition, the BCAST Service Application block 202 notifies a Notification Generation function (NTG) 204-1 located in a BCAST Subscription Management (BSM) block 204 of the change in the BCAST service provided from the Content Creation block 201.

A BCAST Service Distribution/Adaptation (BSD/A) block 203 is responsible for setting up a bearer over which it will transmit the BCAST service data provided from the BCAST Service Application block 202, determining transmission scheduling of the BCAST service, and generating mobile broadcast guide, and is connected to a Broadcast Distribution system (BDS) 206 for providing the BCAST service and an Interaction Network 207 supporting interactive communication. In addition, the BCAST Service Distribution/Adaptation block 203 includes a Notification Distribution Adaptation function (NTDA) 203-1 and receives the notification message transmitted from the BCAST Subscription Management block 204 and transmits the notification message to one or more users via the BDS 206 or the Interaction Network 207.

The BCAST Subscription Management block 204 manages subscription information for the receipt of the BCAST service, service provisioning information, and device information for a device receiving the BCAST service. In particular, the BCAST Subscription Management block 204 has the Notification Generation function (NTG) 204-1 and generates a notification message by receiving the information on a notification event from the Content Creation block 201 or the BDS 206, or generates a notification message for the BCAST service event.

A BDS Service Distribution function 205 serves to distribute all of the received BCAST services through a broadcast channel or an interaction channel, and is an entity that can exist or not exist according to the type of the BDS 206.

The BDS 206 is a network that transmits BCAST service, and can be, for example, DVB-H, 3GPP-based MBMS, and 3GPP2-based BCMCS. In addition, when there is a change in transmitting a particular BCAST service, the BDS 206 transmits a notification event indicating the change to the BCAST Service Distribution/Adaptation block 203 via an X-1 interface 231 or an NT-B1 interface 224 if the BDS Service Distribution function 205 exists.

The Interaction Network 207 transmits BCAST service on a point-to-point basis, or interactively exchanges control information and additional information related to the reception of the BCAST service, and can be, for example, an existing cellular network.

A Terminal 208 is a terminal that is capable of receiving the BCAST service, and can be connected to the cellular network according to terminal capability. For example, the Terminal 208 includes a terminal, i.e. cellular phone, that is capable of connecting with the cellular network. The Terminal 208 performs an appropriate operation by receiving a notification message transmitted via an NT-5 interface 225 by a Notification Client function (NTC) 208-1, or performs an appropriate operation by receiving a notification message transmitted via an NT-6 interface 226.

A description will now be made of interfaces between key logical entities of FIG. 2.

An NT-1 interface 221 is an interface between the Notification Event Function 202-1 located in the BCAST Service Application block 202 and the Content Creation block 201, and is used for delivering a notification event occurring in the Content Creation block 201 to the Notification Event Function 202-1.

An NT-3 interface 222 is an interface between the Notification Event Function 202-1 located in the BCAST Service Application block 202 and the Notification Generation function 204-1 of the BCAST Subscription Management block 204, and delivers information necessary for the generation of a notification event or a notification message so that the Notification Generation function 204-1 can generate the notification message.

An NT-4 interface 223 is an interface between the Notification Generation function 204-1 located in the BCAST Subscription Management block 204 and the Notification Distribution Adaptation function 203-1 of the BCAST Service Distribution/Adaptation block 203, and is used for transmitting the notification message generated in the Notification Generation function 204-1 to the Notification Distribution Adaptation function 203-1 so that it is transmitted via the BDS 206 or the Interaction Network 207, or delivering the notification event occurring in the BDS 206 from the Notification Distribution Adaptation function 203-1 to the Notification Generation function 204-1.

An NT-5 interface 225 is an interface used when a notification message transmitted from the Notification Distribution Adaptation function 203-1 of the BCAST Service Distribution/Adaptation block 203 is directly transmitted to the Terminal 208 through the broadcast channel. The NT-5 interface 225 is used for transmitting a notification message to one or more terminals.

An NT-6 interface 226 is an interface used when a notification message transmitted from the Notification Distribution Adaptation function 203-1 of the BCAST Service Distribution/Adaptation block 203 is directly transmitted to the Terminal 208 through the dedicated channel with the Terminal 208 via the Interaction Network 207 or through the broadcast channel provided in the Interaction Network 207. The NT-6 interface 226 is used for transmitting the notification message to one or more terminals.

An NT-B1 interface 224 is an interface between the BCAST Service Distribution/Adaptation block 203 and the BDS Service Distribution function 205, and is used for establishing a transmission path to be used in the BDS 206 by the BCAST Service Distribution/Adaptation block 203, or a reception path of the notification event occurring in the BDS 206.

An X-1 interface 231 is an interface between the BCAST Service Distribution/Adaptation block 203 and the BDS 206, and is used for establishing a transmission path to be used in the BDS 206 by the BCAST Service Distribution/Adaptation block 203 or a reception path of the notification event occurring in the BDS 206 when the BDS Service Distribution function 205 does not exist. When the BDS Service Distribution function 205 exists, the X-1 interface 231 is used as an interface between the BDS 206 and the BDS Service Distribution function 205 for delivering the notification event occurring in the BDS 206.

An X-2 interface 232 is an interface between the BCAST Service Distribution/Adaptation block 203 and the Interaction Network 207, and is used for establishing a transmission path to be used in the Interaction Network 207 by the BCAST Service Distribution/Adaptation block 203 when the BDS Service Distribution function 205 does not exist. When the BDS Service Distribution function 205 exists, the X-2 interface 232 is used as an interface between the BDS 206 and the Interaction Network 207 for setting up a bearer over which the notification message will be transmitted from the Interaction Network 207.

An X-3 interface 233 is an interface between the BDS 206 and the Terminal 208, and is used for the BCAST service or all messages transmitted through the broadcast channel.

An X-4 interface 234 is a broadcast channel interface between the BDS Service Distribution function 205 and the Terminal 208.

An X-5 interface 235 is an interaction channel interface between the BDS Service Distribution function 205 and the Terminal 208.

An X-6 interface 236 is an interaction channel interface with which the Interaction Network 207 can transmit BCAST service-related control information.

The Notification Event Function 202-1 delivers the information necessary for generating a notification message to the Notification Generation function 204-1, and upon recognizing occurrence of a notification-required event, delivers information on the notification event to the Notification Generation function 204-1. The Notification Generation function 204-1 generates a notification message by receiving the notification event and the information necessary for the generation of the notification message from the Notification Event Function 202-1, or generates a notification message using the notification event of the BDS 206 received through the Notification Distribution Adaptation function 203-1, and transmits the generated notification message to the Notification Distribution Adaptation function 203-1. The notification message can be generated (i) when there is a need to notify another start of the service, (ii) when there is a need to transmit a new mobile broadcast guide upon receipt of a notification indicating a change in the service information from the Content Creation block 201, and (iii) when a particular event occurs in the BDS 206 (i.e., an emergency event).

The Notification Distribution Adaptation function 203-1 serves to transmit a notification message via the NT-5 225 or the NT-6 226, and upon receiving from the BDS 206 a notification indicating a change in a particular mobile broadcast service, for example, indicating adjustment of a data rate based on the wireless network environment or an impossibility of the service, serves to deliver the corresponding notification event to the Notification Generation function 204-1 via the NT-4 223.

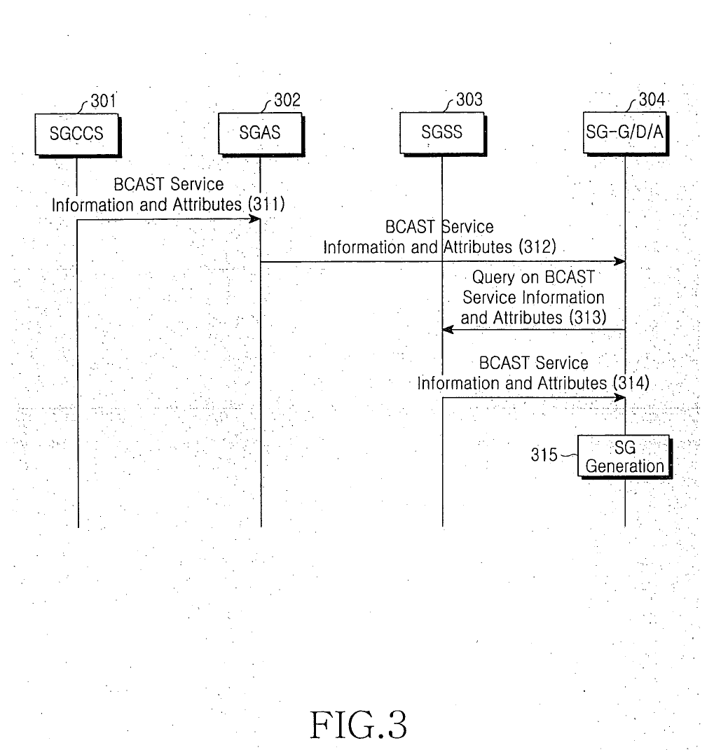

FIG. 3 is a signaling diagram illustrating an exemplary message flow between logical entities for providing a service guide in a mobile broadcast system according to an embodiment of the present invention. Herein, reference numeral 301 denotes the SGCCS 102 of FIG. 1, reference numeral 302 denotes the SGAS 105 of FIG. 1, reference numeral 303 denotes the SGSS 114 of FIG. 1, and reference numeral 304 denotes the SG-G/D/A 109, 110 and 111 of FIG. 1.

Referring to FIG. 3, in step 311, the SGCCS 301 delivers content information and attributes associated with the BCAST service to the SGAS 302. In step 312, the SGAS 302 delivers the broadcast content/service information and attributes to the SG-G/D/A 304 according to a BCAST format using the attributes provided from the SGCCS 301. In step 313, the SG-G/D/A 304 sends a request for provisioning information to the SGSS 303. In step 314, the SGSS 303 provides the provisioning information to the SG-G/D/A 304. In step 315, the SG-G/D/A 304 generates a service guide (SG) depending on the provided information.

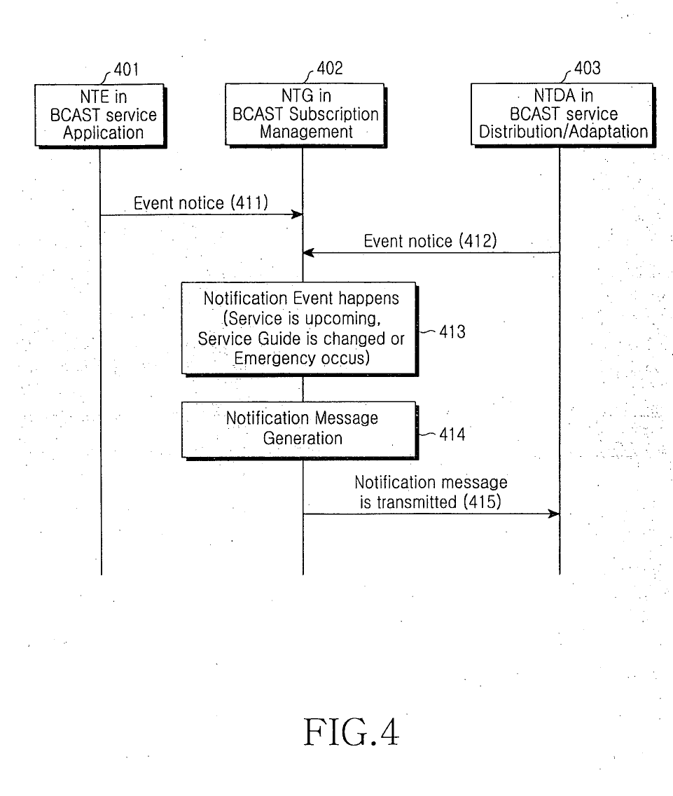

FIG. 4 is a signaling diagram illustrating an exemplary message flow between logical entities for providing a notification message in a mobile broadcast system according to an embodiment of the present invention. Herein, reference numeral 401 denotes the Notification Event Function (NTE) 202-1 in the BCAST Service Application block 202 of FIG. 2, reference numeral 402 denotes the Notification Generation function (NTG) 204-1 in the BCAST Subscription Management block 204, and reference numeral 403 denotes the Notification Distribution Adaptation function (NTDA) 203-1 in the BCAST Service Distribution/Adaptation block 203.

Referring to FIG. 4, in step 411 and/or 412, the notification event occurring in the NTE 401 and the NTDA 403 is delivered to the NTG 402, or a notification event occurs in the NTG 402 or the BDS 206. If a notification event occurs in the Content Creation block 201 or the BSA 202, the NTE 401 delivers an Event notice to the NTG 402 in the BCAST Subscription Management block 204 via the NT-3 interface 222 in step 411. If the notification event is generated from the BCAST Service Distribution/Adaptation block 203 or the BDS 206, the NTDA 403 delivers the notification event to the NTG 402 over the NT-4 interface 223 in step 412. In step 413, a notification event can be spontaneously generated in the BSM 204 and is then delivered to the NTG 402.

As described above, the NTG 402 is provided with the notification event itself or via the NT-3 interface 222 or the NT-4 interface 223. In step 414, the NTG 402 generates a notification message according to the notification event, and then delivers the notification message to the NTDA 403 via the NT-4 interface 223 in step 415.

Before a detailed description of embodiments of the present invention is given, a message schema table used in the present invention will be described for a better understanding of the invention. The term ‘Name’ denotes names of elements and attributes constituting the corresponding message. The term ‘Type’ denotes whether the corresponding name corresponds to the type of element or attribute. Each element has values of E1, E2, E3 and E4. The term E1 indicates an upper element for the whole message, E2 indicates a sub-element of E1, E3 indicates a sub-element of E2, and E4 indicates a sub-element of E3. The attribute is indicated by A, and A indicates an attribute of the corresponding element. For example, A under E1 indicates an attribute of E1.

The term ‘Category’ is used for indicating whether a corresponding element or attribute is mandatory, and has a value M if the value is mandatory, and a value O if the value is optional. The term ‘Cardinality’ indicates relations between the elements, and has values of ‘0’, ‘0 . . . 1’, ‘1’, ‘0 . . . n’, and ‘1 . . . n’, where “0” denotes an optional relation, “1” denotes a mandatory relation, and ‘n’ denotes the possibility of having a plurality of values. For example, ‘0 . . . n’ denotes the possibility that there is no corresponding element or that there are n corresponding elements. The term ‘Description’ defines the meaning of the corresponding element or attribute. The term ‘Data Type’ indicates a data type of the corresponding element or attribute. Therefore, a message format can be shown as illustrated below in Table 6.

TABLE 6

| | | | | | |
|---|---|---|---|---|---|
| Name | Type | Category | Cardinality | Description | Data Type |

Although several information elements necessary for the generation request/response of the service guide and notification event according to an exemplary embodiment of the present invention will be described herein, the messages proposed in embodiments of the present invention will not necessarily include all of the information elements, and can include some or all of the information elements according to intentions or needs of the designer.

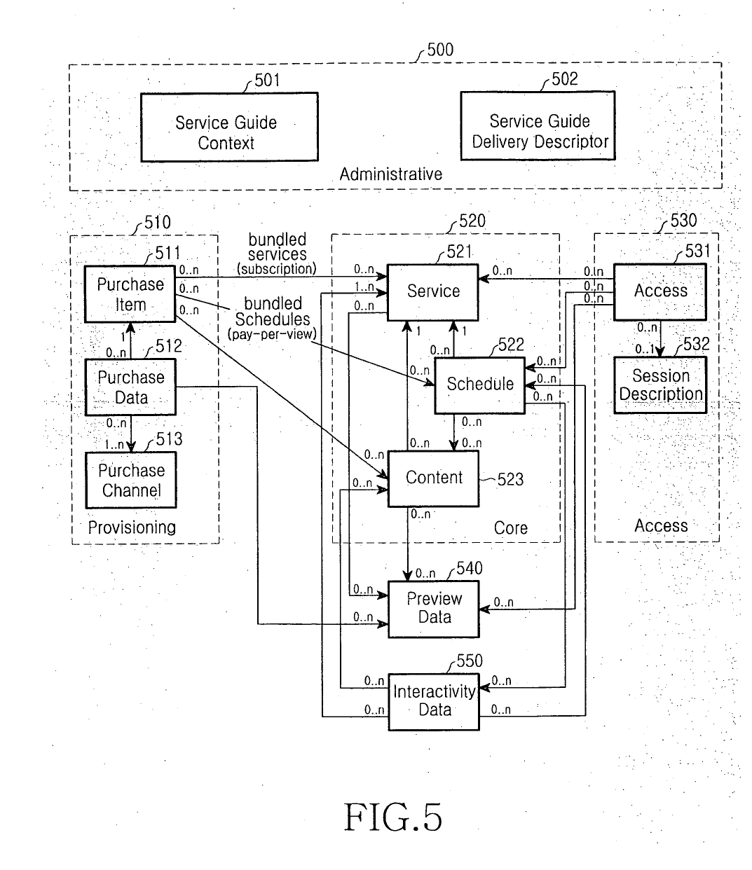

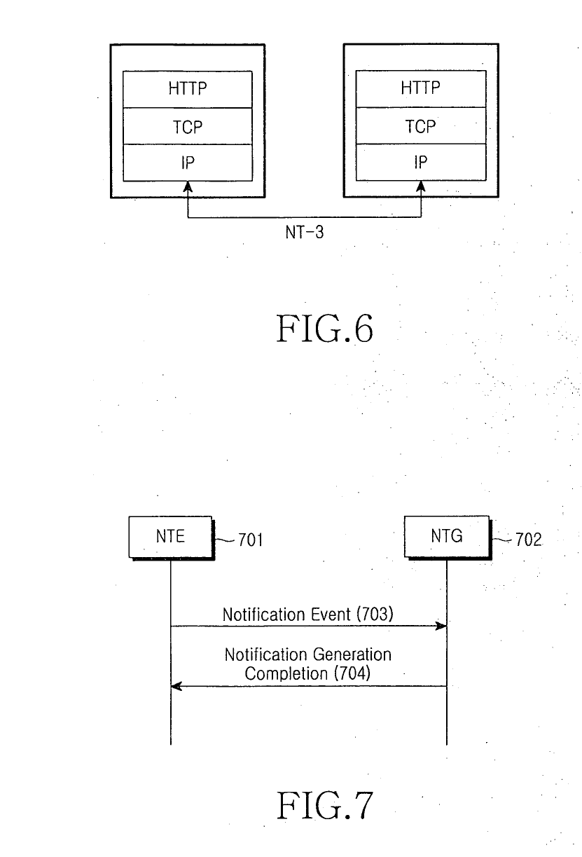

FIG. 6 is a block diagram illustrating an exemplary protocol stack that can be used for transmitting a notification event in an NT-3 interface according to an embodiment of the present invention. The message delivered over the NT-3 interface can be delivered in Text or XML form. The corresponding message will be described in greater detail below with reference to FIG. 7.

The message over the NT-3 interface is transmitted using Internet Protocol (IP), Transfer Control Protocol (TCP), and/or Hyper Text Transfer Protocol (HTTP), and the NTE in the BSA requests the generation of a notification message by sending a notification event message to the NTG in the BSM through HTTP POST. After receiving the message from the NTE, the NTG can transmit the results on the notification message generation along with an HTTP RESPONSE message, or can send a result message through HTTP POST.

FIG. 7 is a signaling diagram illustrating an exemplary process of transmitting a message over an NT-3 interface according to an embodiment of the present invention.

In step 703, an NTE 701 sends a request for the generation of a notification message to an NTG 702. The message provided in step 703 is shown by way of example in Table 7A to Table 7D below. In step 704, the NTG 702 generates a notification message depending on the information received from the NTE 701, and then sends a notification generation completion message to the NTE 701. If the notification message is immediately generated and sent, the NTG 702 can send a result message along with an HTTP Response message in response to the request message provided in step 703. However, if time is required for generating the notification message, the NTG 702 can send the result message to the NTE 701 through NTGReqId and BSAAddress of the NTGReq received in step 703 using HTTP POST at the generation completion time after closing the session to the NTE 701. Details of the result message are shown by way of example in Table 8 below.

In step 704, responses to several requests from the NTE 701 can be sent from the NTG 702 to the NTE 701 using one message.

TABLE 7A

| Name | Type | Category | Cardinality | Description | Data Type |
|---|---|---|---|---|---|
| NTEReq | E | | | Specifies the Request message of | |
| | | | | Notification Event from NTE to NTG. | |
| | | | | Contains the following elements: | |
| | | | | NTEId | |
| | | | | BSAAddress | |
| NTEId | A | M | 1 | Identifier of Notification Event from | unsignedInt |
| | | | | BSA. | (32 bits) |
| BSAAddress | A | M | 1 | BSA Address to receive the response of | AnyURI |
| | | | | this request. | |
| NotificationEvent | E1 | M | 1 . . . N | Specifies the Notification Event from | |
| | | | | CC. | |
| | | | | Contains the following attributes: | |
| | | | | NotificationType | |
| | | | | Validity | |
| | | | | Contains the following elements: | |
| | | | | Name | |
| | | | | Description | |
| | | | | Priority | |
| | | | | ExtensionURL | |
| | | | | MediaInformation | |
| NotificationType | A | M | 1 | Notification Type: | Integer |
| | | | | If NotificationType = 0, this message is | |
| | | | | a user-oriented message, such as notice | |
| | | | | from SP, Multimedia message, | |
| | | | | emergency, and so forth. | |
| | | | | If NotificationType = 1, this message is | |
| | | | | terminal-oriented message, such as start | |
| | | | | of service or file download, and so | |
| | | | | forth. | |
| | | | | Other NotificationType can be | |
| | | | | determined due to service providers, | |
| | | | | operators, or broadcasters' purpose. | |

TABLE 7B

| Name | Type | Category | Cardinality | Description | Data Type |
|---|---|---|---|---|---|
| Validity | A | O | 0 . . . 1 | Valid time of Notification message | Integer (32 |
| | | | | fragment. | bits) |
| | | | | If Validity is specified, Notification | expressed |
| | | | | message should expire at the specified | as NTP |
| | | | | time. | time. |
| Name | E2 | O | 0 . . . N | Name or title of notification message, | String |
| | | | | possibly in multiple languages. | |
| | | | | The language is expressed using built- | |
| | | | | in XML attribute xml:lang with this | |
| | | | | element. | |
| Description | E2 | O | 0 . . . N | Description or Messages of | String |
| | | | | Notification, possibly in multiple | |
| | | | | languages. | |
| | | | | The language is expressed using built- | |
| | | | | in XML attribute xml:lang with this | |
| | | | | element. | |
| Priority | E2 | M | 1 | Defines the priority of this notification | Integer |
| | | | | event. This information applied to | |
| | | | | generate presentation type of | |
| | | | | Notification Message. | |
| ExtensionURL | E2 | O | 0 . . . N | URL containing additional information | AnyURI |
| | | | | related to notification message. | |

TABLE 7C

| Name | Type | Category | Cardinality | Description | Data Type |
|---|---|---|---|---|---|
| MediaInformation | E2 | O | 0 . . . 1 | Media Information which is needed to | |
| | | | | construct multimedia notification | |
| | | | | messages. | |
| | | | | Contains the following elements: | |
| | | | | Picture | |
| | | | | Video | |
| | | | | Audio | |
| Picture | E3 | O | 0 . . . N | Defines how to obtain a picture and | |
| | | | | MIME type. | |
| | | | | Contains the following elements: | |
| | | | | MIMEtype | |
| | | | | PictureURI | |
| MIMEtype | A | O | 0 . . . 1 | MIME type of Picture. | String |
| PictureURI | A | O | 0 . . . 1 | The URI referencing the picture. | AnyURI |
| Video | E3 | O | 0 . . . N | Defines how to obtain a video and | |
| | | | | MIME type. | |
| | | | | Contains the following elements: | |
| | | | | MIMEtype | |
| | | | | VideoURI | |
| MIMEtype | A | O | 0 . . . 1 | MIME type of Video. | String |
| VideoURI | A | O | 0 . . . 1 | The URI referencing the video. | AnyURI |

TABLE 7D

| Name | Type | Category | Cardinality | Description | Data Type |
|---|---|---|---|---|---|
| Audio | E3 | O | 0 . . . N | Defines how to obtain an audio and | |
| | | | | MIME type. | |
| | | | | Contains the following elements: | |
| | | | | MIMEtype | |
| | | | | AudioURI | |
| MIMEtype | A | O | 0 . . . 1 | MIME type of Audio. | String |
| AudioURI | A | O | 0 . . . 1 | The URI referencing the audio. | AnyURI |

TABLE 8

| Name | Type | Category | Cardinality | Description | Data Type |
|---|---|---|---|---|---|
| NTERes | E | | | Specifies the Response message for | |
| | | | | NTEReq. | |
| | | | | Contains the following elements: | |
| | | | | NTEId | |
| NTEId | E1 | M | 0 . . . N | Identifier of NTEReq. | unsignedInt |
| | | | | Contains the following attributes: | (32 bits) |
| | | | | Response | |
| Response | A | M | 1 | Specifies the result of how NTERes is | Integer |
| | | | | handled in BSM. | (8 bits) |
| | | | | If Response = 0, Notification Message is | |
| | | | | generated and delivered to NTD/A. | |
| | | | | If Response = 1, Notification Message | |
| | | | | Generation has failed and | |
| | | | | Retransmission is requested. | |

FIG. 5 is a block diagram illustrating an exemplary data model for a service guide for generating a service guide in OMA BCAST according to an embodiment of the present invention.

The service guide data model is comprised of an Administrative group 500 for providing upper element information of the entire service guide, a Provisioning group 510 for providing subscription and purchase information, a Core group 520 for providing core information of the service guide, such as service, content, and service scheduling, and an Access group 530 for providing access information for an access to the service or content. Each element will be described in greater detail below.

A Service Guide Context 501 provides a method in which the terminal can recognize a service guide, and also provides information on an operator for distributing the service guide, or location information, and connection information with a Service Guide Delivery Descriptor 502.

The Service Guide Delivery Descriptor 502 provides information on a delivery session where a Service Guide Delivery Unit (SGDU) containing a fragment, which is the minimum unit constituting the service guide, is located, and also provides grouping information for the SGDU and information on an entry point for receiving a notification message.

A Service fragment 521, an upper aggregate of the contents included in the broadcast service as the center of the entire service guide, provides information on service content, genre, service location and so forth. A Schedule fragment 522 provides time information of each of the contents included in the Streaming and Downloading services. A Content fragment 523 provides a detailed description of the broadcast contents, target user group, service location, and genre. The Access group 530 provides access-related information for allowing the user to view the service, and also provides a delivery method for the corresponding access session, and session information. A Session Description fragment 532 can also be included in an Access fragment 531 of the Access group 530, and provides location information in URI form, so that the terminal can detect the corresponding session description information.

In addition, the Session Description fragment 532 provides address information and codec information for the multimedia contents existing in the corresponding session. A Purchase Item fragment 511 provides a bundle of service, content and time to help a user subscribe to or purchase the corresponding purchase item. A Purchase Data fragment 512 includes detailed purchase and subscription information such as price information and promotion information for the service or service bundle.

A Purchase Channel fragment 513 provides access information for subscription or purchase. The Service Guide Context 501 allows the terminal to recognize a service guide, and provides location information or owner information based on which the terminal can receive the service guide. The Service Guide Delivery Descriptor 502 provides grouping information for an entry point for service guide reception and the SGDU indicative of a container of the fragment. A preview data block 540 and a interactivity data block 550 can also be provided.

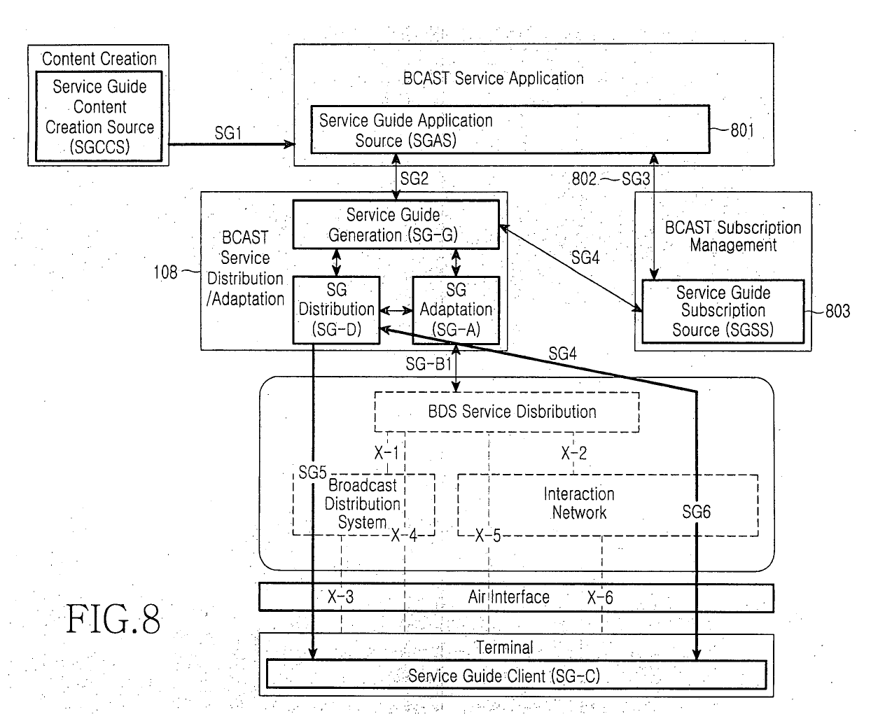

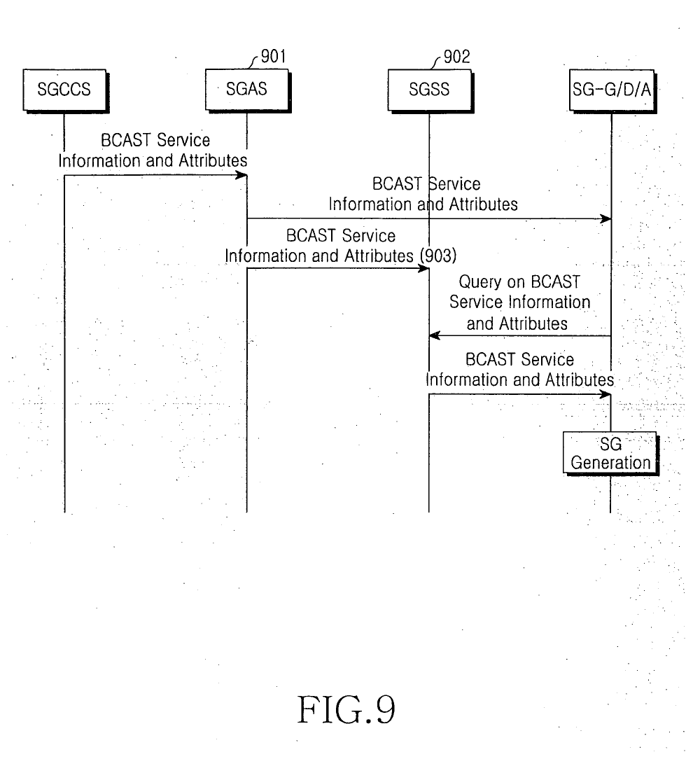

The service guide of FIG. 5 is preferably generated in the SG-G 109 of FIG. 1, and information (hereafter, provisioning information) of the Provisioning group 510 is preferably provided by the SGCC 114 of FIG. 1. The corresponding provisioning information is delivered in step 314 of FIG. 3, and the information in step 314 can be delivered without the Query of step 313. However, because the information in step 313 is not necessarily required for obtaining the information for provisioning, the SGCC 114 preferably should previously have the corresponding service and contents, or scheduling information. Therefore, as described in greater detail below, there is a need for an SG3 interface 802 for information exchange between the SGAS 801 and the SGSS 803 of FIG. 8, and service/content and its scheduling information should be provided from the SGAS 901 to the SGSS 902 through step 903 as shown in FIG. 9.

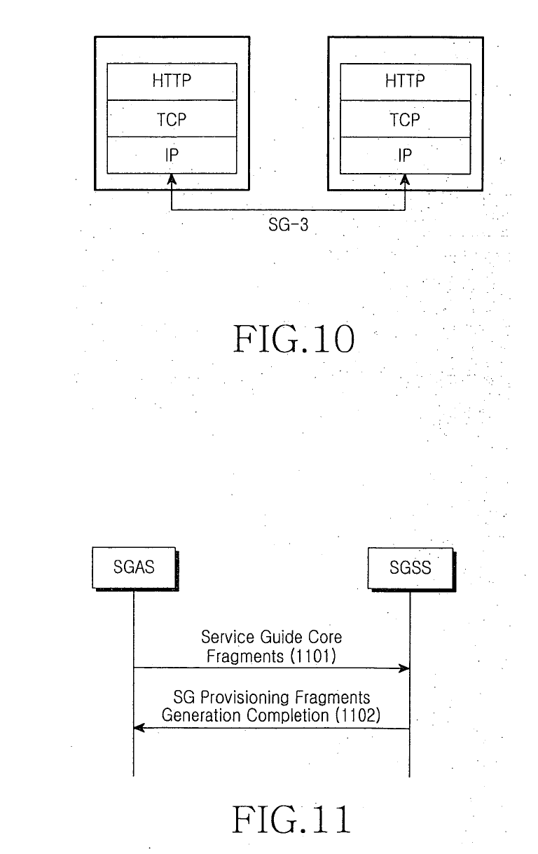

FIG. 10 is a block diagram illustrating an exemplary protocol stack used for transmitting information related to a service guide in an SG-3 interface according to an embodiment of the present invention.

A message delivered over the SG-3 (for example, 802 of FIG. 8) can be delivered in Text or XML form. The corresponding message will be described in greater detail below with reference to FIG. 11.

The message over the SG-3 802 is delivered using IP, TCP and/or HTTP, and the SGAS in the BSA transmits a service/content-related message to the SGSS in the BSM through an HTTP POST. After receiving the message from the SGAS, the SGSS can transmit the results on the provisioning information generation along with an HTTP RESPONSE message, or can send a result message through the HTTP POST.

FIG. 11 is a signaling diagram illustrating an exemplary process of transmitting a message over an SG-3 according to an embodiment of the present invention. With reference to FIG. 11, a description will now be made of a process of transmitting a message over an SG-3.

In step 1101, an SGAS (for example, 901 of FIG. 9) provides service/content information and schedule information in the service guide data model as described in FIG. 5, to an SGSS (for example, 902 of FIG. 9). The schedule information may not be provided as part of the delivered information, and the corresponding schedule can be generated in the BSD/A and then provided while the SGSS 803 is generating a service guide. The message provided in step 1101 is shown by way of example in Table 9 below. In Table 9, Service is followed by the ServiceInfo of Table 10A to Table 10D, Content is followed by the ContentInfo of Table 11A to Table 11D, and Schedule is followed by the ScheduleInfo of Table 12A to Table 12H. In step 1102, the SGSS 902 generates provisioning information of the service guide with the information provided from the SGAS 901 and then sends a generation completion message to the SGAS 901.

If the service guide is immediately generated and sent, the SGSS 902 can send a result message along with an HTTP Response message in response to the request message provided in step 1101. However, if time is required for generating Provisioning information of the service guide, the SGSS 902 can send a result message to the SGAS 901 through HTTP POST using SGASProvReqId and BSAAddress at the generation completion time after closing the session to the SGSS 902. Details of the result message are shown by way of example in Table 13 below. In step 1102, responses to several requests from the SGAS can be sent from the SGSS 902 to the SGAS 901 using one message.

TABLE 9

| Name | Type | Category | Cardinality | Description | Data Type |
|---|---|---|---|---|---|
| SGASProvReq | | | | Specifies the request message to | |
| | | | | generate Provisioning Section of | |
| | | | | Service Guide. Service, Schedule, and | |
| | | | | Content information are possible | |
| | | | | values. | |
| | | | | Contains the Following attributes: | |
| | | | | SGASProvReqId | |
| | | | | Contains the following elements: | |
| | | | | Service | |
| | | | | Content | |
| | | | | Schedule | |
| SGASProvReqId | A | M | 1 | Identifier of SGASProvReq which is | unsignedInt |
| | | | | the message for SGAS to request | (32 bits) |
| | | | | Provisioning Information Generation | |
| | | | | to SGSS. | |
| BSAAddress | A | M | 1 | BSA Address to receive the response | AnyURI |
| | | | | of this request. | |
| Service | E1 | O | 0 . . . N | Specifies the Service Information. | ServiceInfo |
| Content | E1 | O | 0 . . . N | Specifies Content Information. | ContentInfo |
| Schedule | E1 | O | 0 . . . N | Specifies Schedule Information. | ScheduleInfo |

TABLE 10A

| Name | Type | Category | Cardinality | Description | Data Type |
|---|---|---|---|---|---|
| ServiceInfo | | | | Specifies the Service Information. | |
| | | | | Contains the following attributes: | |
| | | | | id | |
| | | | | version | |
| | | | | type | |
| | | | | ServiceProtection | |
| | | | | Contains the following elements: | |
| | | | | ExtensionURL | |
| | | | | GlobalServiceID | |
| | | | | Name | |
| | | | | Description | |
| | | | | ParentalRating | |
| | | | | TargetUserProfile | |
| | | | | Genre | |
| | | | | UserRating | |
| | | | | Broadcast area | |
| id | A | M | 1 | ID of the service fragment, globally | AnyURI |
| | | | | unique. | |
| version | A | M | 1 | Version of this fragment. The newer | unsignedInt |
| | | | | version overrides the older one as soon | (32 bits) |
| | | | | as it has been received. | |
| type | A | M | 1 | Type of the service. Allowed values | Integer |
| | | | | are: | (8 bits) |
| | | | | 0 - unspecified | |
| | | | | 1 - Basic TV, non-interactive | |
| | | | | 2 - Basic TV, interactive | |
| | | | | 3 - Clipcast | |
| | | | | 4 - Mixed Basic TV and Clipcast non- | |
| | | | | interactive | |
| | | | | 5 - Mixed Basic TV and Clipcast, with | |
| | | | | interaction | |
| | | | | 6 - Basic Radio, non-interactive | |
| | | | | 7 - Basic Radio, interactive | |
| | | | | 8 - File download services | |
| | | | | 9 - Software management services | |
| | | | | 10 - Notification services | |
| | | | | 11-200 reserved for future use | |
| | | | | 201-255 reserved for proprietary use | |

TABLE 10B

| Name | Type | Category | Cardinality | Description | Data Type |
|---|---|---|---|---|---|
| ServiceProtection | A | O | 0 . . . 1 | Specifies if the service is encrypted | Boolean |
| | | | | (false) or not (true). This is | |
| | | | | recommendation value by SGAS. | |
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| GlobalServiceID | E1 | O | 0 . . . 1 | The globally unique identifier | AnyURI |
| | | | | identifying the service that this Service | |
| | | | | fragment describes. | |
| Name | E1 | M | 1 . . . N | Name of the Service, possibly in | String |
| | | | | multiple languages. The language is | |
| | | | | expressed using built-in XML attribute | |
| | | | | xml:lang with this element. | |
| Description | E1 | O | 0 . . . N | Description, possibly in multiple | String |
| | | | | languages. The language is expressed | |
| | | | | using built-in XML attribute xml:lang | |
| | | | | with this element. | |
| ParentalRating | E1 | O | 0 . . . 1 | The rating level defining criteria | String |
| | | | | parents may use to determine whether | |
| | | | | the associated item is suitable for | |
| | | | | access by children, defined according | |
| | | | | to the regulatory requirements of the | |
| | | | | service area. | |

TABLE 10C

| Name | Type | Category | Cardinality | Description | Data Type |
|---|---|---|---|---|---|
| TargetUserProfile | E1 | O | 0 . . . 1 | Profile of the users who the service or | |
| | | | | content is targeting. For example, age, | |
| | | | | gender, occupation, and so forth. | |
| Genre | E1 | O | 0 . . . N | Classification of service associated | String |
| | | | | with characteristic form (e.g. comedy, | |
| | | | | drama and so forth). | |
| UserRating | E1 | O | 0 . . . N | Rating information collected from users | Integer |
| | | | | (e.g. favoritism, or recommended age | |
| | | | | limit). | |
| broadcast_area | E1 | O | 0 . . . 1 | Broadcast area to include location | |
| | | | | information for BCAST contents. | |
| | | | | Sub-elements: | |
| | | | | target_area | |
| target_area | E2 | O | 0 . . . N | The target area to distribute contents | |
| | | | | (as specified in the [OMA MLP] with | |
| | | | | modifications). | |
| | | | | Sub-elements: | |
| | | | | Shape | |
| | | | | cc | |
| | | | | name_area | |
| | | | | zip_code | |
| shape | E3 | O | 0 . . . 1 | Shapes used to represent and describe a | See |
| | | | | geographic area (as specified in the | [OMA |
| | | | | [OMA MLP]). | MLP] |

TABLE 10D

| Name | Type | Category | Cardinality | Description | Data Type |
|---|---|---|---|---|---|
| Cc | E3 | O | 0 . . . 1 | Country code, 1-3 digits e.g. 355 for | See |
| | | | | Albania (as specified in the [OMA | [OMA |
| | | | | MLP]). | MLP] |
| name_area | E3 | O | 0 . . . 1 | Geopolitical name of area such as | See |
| | | | | ‘Seoul’ (as specified in the [OMA | [OMA |
| | | | | MLP]). | MLP] |
| zip_code | E3 | O | 0 . . . 1 | Zip code. | Integer |

TABLE 11A

| Name | Type | Category | Cardinality | Description | Data Type |
|---|---|---|---|---|---|
| ContentInfo | | | | Specifies Content Information. | |
| | | | | Contains the following attributes: | |
| | | | | id | |
| | | | | version | |
| | | | | ServiceIDRef | |
| | | | | ContentType | |
| | | | | Contains the following sub-elements: | |
| | | | | ExtensionURL | |
| | | | | Name | |
| | | | | Description | |
| | | | | ParentalRating | |
| | | | | TargetUserProfile | |
| | | | | Genre | |
| | | | | UserRating | |
| | | | | broadcast_area | |
| | | | | FileDescription | |
| id | A | M | 1 | ID of the content fragment, globally | AnyURI |
| | | | | unique. | |
| version | A | M | 1 | Version of this fragment. The newer | unsignedInt |
| | | | | version overrides the older one as soon | (32 bits) |
| | | | | as it has been received. | |
| ServiceIDRef | A | M | 1 | Reference to the service fragment to | AnyURI |
| | | | | which the Content fragment belongs. | |
| ContentType | A | M | 1 | Type of the media content, defined by | String |
| | | | | MIME media types [RFC2046]. | |

TABLE 11B

| Name | Type | Category | Cardinality | Description | Data Type |
|---|---|---|---|---|---|
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| Name | E1 | M | 1 . . . N | Name of the Content fragment, | String |
| | | | | possibly in multiple languages. The | |
| | | | | language is expressed using built-in | |
| | | | | XML attribute xml:lang with this | |
| | | | | element. | |
| Description | E1 | O | 0 . . . N | Description, possibly in multiple | String |
| | | | | languages. | |
| | | | | The language is expressed using built- | |
| | | | | in XML attribute xml:lang with this | |
| | | | | element. | |
| ParentalRating | E1 | O | 0 . . . N | The rating level defining criteria | Integer |
| | | | | parents may use to determine whether | |
| | | | | the associated item is suitable for | |
| | | | | access by children, defined according | |
| | | | | to the regulatory requirements of the | |
| | | | | service area. | |
| | | | | The recommended age limit. | |
| | | | | This age limit rating level overrides the | |
| | | | | rating level age limit defined for the | |
| | | | | service during the validity of the | |
| | | | | Schedule fragment. | |
| | | | | If there are two overlapping schedule | |
| | | | | fragments with a different parental | |
| | | | | rating, then the one with most | |
| | | | | restrictive parental rating defined for | |
| | | | | the schedule fragment overrides the | |
| | | | | other. | |

TABLE 11C

| Name | Type | Category | Cardinality | Description | Data Type |
|---|---|---|---|---|---|
| TargetUserProfile | E1 | O | 0 . . . 1 | Profile of the users who the service or | |
| | | | | content is targeting. For example, age, | |
| | | | | gender, occupation, and so forth. | |
| Genre | E1 | O | 0 . . . N | Classification of content associated | String |
| | | | | with characteristic form (e.g. comedy, | |
| | | | | drama and so forth). | |
| UserRating | E1 | O | 0 . . . 1 | Rating information collected from users | Integer |
| | | | | (e.g. favoritism, or recommended age | |
| | | | | limit). | |
| broadcast_area | E1 | O | 0 . . . 1 | Broadcast area to include location | |
| | | | | information for BCAST contents. | |
| | | | | Sub-elements: | |
| | | | | target_area | |
| target_area | E2 | O | 0 . . . N | The target area to distribute contents | |
| | | | | (as specified in the [OMA MLP] with | |
| | | | | modifications). | |
| | | | | Sub-elements: | |
| | | | | Shape | |
| | | | | cc | |
| | | | | name_area | |
| | | | | zip_code | |
| shape | E3 | O | 0 . . . 1 | Shapes used to represent and describe a | See |
| | | | | geographic area (as specified in the | [OMA |
| | | | | [OMA MLP]). | MLP] |
| cc | E3 | O | 0 . . . 1 | Country code, 1-3 digits e.g. 355 for | See |
| | | | | Albania (as specified in the [OMA | [OMA |
| | | | | MLP]). | MLP] |

TABLE 11D

| Name | Type | Category | Cardinality | Description | Data Type |
|---|---|---|---|---|---|
| name_area | E3 | O | 0 . . . 1 | Geopolitical name of area such as | See |
| | | | | ‘Seoul’ (as specified in the [OMA | [OMA MLP] |
| | | | | MLP]). | |
| zip_code | E3 | O | 0 . . . 1 | Zip code. | Integer |
| FileDescription | E1 | O | 0 . . . 1 | Description of a file or files related to | |
| | | | | this content. | |
| | | | | Attributes: | |
| | | | | Content-Length | |
| | | | | Transfer-Length | |
| | | | | Content-Type | |
| | | | | Content-Encoding | |
| | | | | Content-MD5 | |
| Content-Length | A | O | 0 . . . 1 | See RFC 3926, section 3.4.2. | unsignedLong |
| Transfer-Length | A | O | 0 . . . 1 | See RFC 3926, section 3.4.2. | unsignedLong |
| Content-Type | A | O | 0 . . . 1 | See RFC 3926, section 3.4.2. | String |
| Content- | A | O | 0 . . . 1 | See RFC 3926, section 3.4.2. | String |
| Encoding | | | | | |

TABLE 12A

| Name | Type | Category | Cardinality | Description | Data Type |
|---|---|---|---|---|---|
| ScheduleInfo | | | | Schedule fragment. | |
| | | | | Contains the following attributes: | |
| | | | | id | |
| | | | | version | |
| | | | | ServiceIDRef | |
| | | | | Contains the following sub-elements: | |
| | | | | InteractivityDataIDRef | |
| | | | | ContentIDRef | |
| | | | | ExtensionURL | |
| | | | | Name | |
| | | | | Description | |
| id | A | M | 1 | ID of the Schedule fragment, globally | AnyURI |
| | | | | unique. | |
| version | A | M | 1 | Version of this fragment. The newer | unsignedInt |
| | | | | version overrides the older one as soon | (32 bits) |
| | | | | as it has been received. | |
| ServiceIDRef | A | M | 1 | Reference to the service fragment to | AnyURI |
| | | | | which the schedule fragment belongs. | |

TABLE 12B

| Name | Type | Category | Cardinality | Description | Data Type |
|---|---|---|---|---|---|
| InteractivityData | E1 | O | 0 . . . N | Reference to the interactivity data | AnyURI |
| IDRef | | | | fragment to which the schedule | |
| | | | | fragment belongs. | |
| | | | | This IDRef declares the schedule of the | |
| | | | | file delivery of the InteractivityMedia | |
| | | | | Documents to which the | |
| | | | | InteractivityData fragment points to. | |
| | | | | An InteractivityData fragment can be | |
| | | | | associated with a ScheduleItem | |
| | | | | fragment as well, but that is preferably | |
| | | | | not the purpose of this IDRef. | |
| | | | | It contains the following attributes: | |
| | | | | idRef | |
| | | | | AutoStart | |
| | | | | It contains the following sub-elements: | |
| | | | | Distribution_Window | |
| | | | | The presentation window is actually | |
| | | | | declared by the “Valid_From” and | |
| | | | | “Valid_To” values in the Media Object | |
| | | | | Document. | |
| idRef | A | M | 1 | Identification of the interactivity data | AnyURI |
| | | | | fragment which the Schedule fragment | |
| | | | | relates to. | |
| AutoStart | A | O | 0 . . . 1 | Indicates whether the associated | Boolean |
| | | | | interactivity data will be automatically | |
| | | | | activated. | |
| | | | | If the value of AutoStart is true, the | |
| | | | | associated interactivity data will be | |
| | | | | automatically activated at the validity | |
| | | | | of the media object document. | |
| | | | | If the value of AutoStart is false, the | |
| | | | | associated interactivity data will not be | |
| | | | | automatically activated, but can be | |
| | | | | activated at any time of the validity of | |
| | | | | the media object document upon the | |
| | | | | user's request. | |
| | | | | It is preferred that the terminal settings | |
| | | | | allow the users to configure whether to | |
| | | | | allow interactivity data to be | |
| | | | | automatically activated without users' | |
| | | | | request. | |

TABLE 12C

| Name | Type | Category | Cardinality | Description | Data Type |
|---|---|---|---|---|---|
| Distribution_Window | E2 | O | 0 . . . N | Time interval in which the referenced | |
| | | | | interactivity data specified by | |
| | | | | ContentID is available for delivery. | |
| | | | | It contains the following attributes: | |
| | | | | Distribution_Start_Time | |
| | | | | Distribution_End_Time | |
| | | | | DWid | |
| | | | | It contains the following sub-elements: | |
| | | | | RepeatType | |
| Distribution_Start_Time | A | O | 0 . . . 1 | Start of Distribution_Window. If not | Integer (32 |
| | | | | given, the validity is assumed to have | bits) |
| | | | | begun at some time in the past. | expressed |
| | | | | | as NTP |
| | | | | | time. |
| Distribution_End_Time | A | O | 0 . . . 1 | End of Distribution_Window. If not | Integer (32 |
| | | | | given, the validity is assumed to end at | bits) |
| | | | | some undefined time in the future. | expressed |
| | | | | | as NTP |
| | | | | | time. |
| DWid | A | O | 0 . . . 1 | Identification of the | Integer |
| | | | | Distribution_Window which each | |
| | | | | Distribution_Window relates to. | |

TABLE 12D

| Name | Type | Category | Cardinality | Description | Data Type |
|---|---|---|---|---|---|
| RepeatType | E3 | O | 0 . . . 1 | Indicates whether the interactivity data | |
| | | | | referenced by the ContentID is repeated | |
| | | | | in distribution according to the | |
| | | | | attributes Unit and Number. | |
| Unit | A | M | 1 | Indicates the unit of time (e.g. hours, | Integer |
| | | | | days, . . .) for which the content is | |
| | | | | repeated in distribution. | |
| Num | A | M | 1 | Number of Units. | Integer |
| ContentIDRef | E1 | O | 0 . . . N | Reference to the content fragments that | |
| | | | | the schedule fragment relates to. | |
| | | | | It contains the following attributes: | |
| | | | | idRef | |
| | | | | AutoStart | |
| | | | | RepeatPlayback | |
| | | | | It contains the following sub-elements: | |
| | | | | Distribution_Window | |
| | | | | Presentation_Window | |
| idRef | A | M | 1 | Identification of the Content fragment | AnyURI |
| | | | | which the Schedule fragment relates to. | |

TABLE 12E

| Name | Type | Category | Cardinality | Description | Data Type |
|---|---|---|---|---|---|
| AutoStart | A | O | 0 . . . 1 | Indicates whether the associated | Boolean |
| | | | | content will be automatically activated. | |
| | | | | If the value of AutoStart is true, the | |
| | | | | associated content will be automatically | |
| | | | | activated at Presentation_Start_Time of | |
| | | | | every affiliated Presentation_Window | |
| | | | | without the user's request. Afterwards, | |
| | | | | as long as Presentation_End_Time of | |
| | | | | Presentation_Window has not elapsed, | |
| | | | | the content can further be activated at | |
| | | | | any other time upon the user's request. | |
| | | | | If the value of AutoStart is false, the | |
| | | | | associated content will not be | |
| | | | | automatically activated, but can be | |
| | | | | activated at any time between | |
| | | | | Presentation_Start_Time and | |
| | | | | Presentation_End_Time of every | |
| | | | | affiliated Presentation_Window upon | |
| | | | | the user's request. | |
| | | | | It is preferred that the terminal settings | |
| | | | | allow the users to configure whether to | |
| | | | | allow content to be automatically | |
| | | | | activated without users' request. | |
| RepeatPlayback | A | O | 0 . . . 1 | Indicates whether the content item | Boolean |
| | | | | referenced by the Presentation Window | |
| | | | | and/or Distribution Window in the | |
| | | | | Schedule fragment is of the repeat | |
| | | | | playback type. | |

TABLE 12F

| Name | Type | Category | Cardinality | Description | Data Type |
|---|---|---|---|---|---|
| Distribution_Window | E2 | O | 0 . . . N | Time interval in which the referenced | |
| | | | | content specified by ContentID is | |
| | | | | available for delivery. | |
| | | | | It contains the following attributes: | |
| | | | | Distribution_Start_Time | |
| | | | | Distribution_End_Time | |
| | | | | DWid | |
| | | | | It contains the following sub-elements: | |
| | | | | RepeatType | |
| Distribution_Start_Time | A | O | 0 . . . 1 | Start of Distribution_Window. If not | Integer (32 |
| | | | | given, the validity is assumed to have | bits) |
| | | | | begun at some time in the past. | expressed |
| | | | | | as NTP |
| | | | | | time. |
| Distribution_End_Time | A | O | 0 . . . 1 | End of Distribution_Window. If not | Integer (32 |
| | | | | given, the validity is assumed to end at | bits) |
| | | | | some undefined time in the future. | expressed |
| | | | | | as NTP |
| | | | | | time. |
| DWid | A | O | 0 . . . 1 | Identification of the | Integer |
| | | | | Distribution_Window which the each | |
| | | | | Distribution_Window relates to. | |
| RepeatType | E3 | O | 0 . . . 1 | Indicates whether the content | |
| | | | | referenced by the ContentID is repeated | |
| | | | | in distribution according to the | |
| | | | | attributes Unit and Number. | |
| Unit | A | M | 1 | Indicates the unit of time (e.g. hours, | Integer |
| | | | | days, . . . ) for which the content is | |
| | | | | repeated in distribution. | |
| Num | A | M | 1 | Number of Units. | Integer |

TABLE 12G

| Name | Type | Category | Cardinality | Description | Data Type |
|---|---|---|---|---|---|
| Presentation_Window | E2 | O | 0 . . . N | Time interval in which the referenced | |
| | | | | content specified by ContentID is | |
| | | | | available for rendering. It contains the | |
| | | | | following attributes: | |
| | | | | Presentation_Start_Time | |
| | | | | Presentation_End_Time | |
| | | | | Duration | |
| | | | | It contains the following sub-elements: | |
| | | | | RepeatType | |
| Presentation_Start_Time | A | O | 0 . . . 1 | Start of Presentation_Window. If not | Integer (32 |
| | | | | given, the validity is assumed to have | bits) |
| | | | | begun at some time in the past. | expressed |
| | | | | | as NTP |
| | | | | | time. |
| Presentation_End_Time | A | O | 0 . . . 1 | End of Presentation_Window. If not | Integer (32 |
| | | | | given, the validity is assumed to end at | bits) |
| | | | | some undefined time in the future. | expressed |
| | | | | | as NTP |
| | | | | | time. |
| Duration | A | O | 0 . . . 1 | Time duration of the referenced content | Integer |
| | | | | for rendering. It informs the user of the | |
| | | | | latest Presentation_Start_Time for | |
| | | | | which the content item can be rendered | |
| | | | | in its entirety. | |
| RepeatType | E3 | O | 0 . . . 1 | Indicates whether the content | |
| | | | | referenced by the ContentID is repeated | |
| | | | | in presentation according to the | |
| | | | | attributes Unit and Number. | |
| Unit | A | O | 1 | Indicates the unit of time (e.g. hours, | Integer |
| | | | | days . . .) for which the content is | |
| | | | | repeated in presentation. | |
| Num | A | O | 1 | Number of Units. | Integer |

TABLE 12H

| Name | Type | Category | Cardinality | Description | Data Type |
|---|---|---|---|---|---|
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| Name | E1 | M | 1 . . . N | Name of the Schedule, possibly in | String |
| | | | | multiple languages. | |
| | | | | The language is expressed using built- | |
| | | | | in XML attribute xml:lang with this | |
| | | | | element. | |
| Description | E1 | O | 0 . . . N | Description, possibly in multiple | String |
| | | | | languages. | |
| | | | | The language is expressed using built- | |
| | | | | in XML attribute xml:lang with this | |
| | | | | element. | |

TABLE 13

| Name | Type | Category | Cardinality | Description | Data Type |
|---|---|---|---|---|---|
| SGASProvRes | E | M | 0 . . . N | Specifies the Response message for | |
| | | | | SGASProvReq. | |
| | | | | Contains the following elements: | |
| | | | | SGASProvRegId | |
| SGASProvReqId | E1 | M | 0 . . . N | Identifier of SGASProvReq | unsignedInt |
| | | | | Contains the following attributes: | (32bits) |
| | | | | Response | |
| Response | A | M | 1 | Specifies the result of how SGSS is | Integer |
| | | | | handled by the SGASProvReq. | (8bits) |
| | | | | If Response = 0, Provisioning is | |
| | | | | generated by SGASProvReq specified | |
| | | | | with SGASProvReqId. | |
| | | | | If Response = 1, Provisioning | |
| | | | | Generation has failed and | |
| | | | | Retransmission is requested. | |

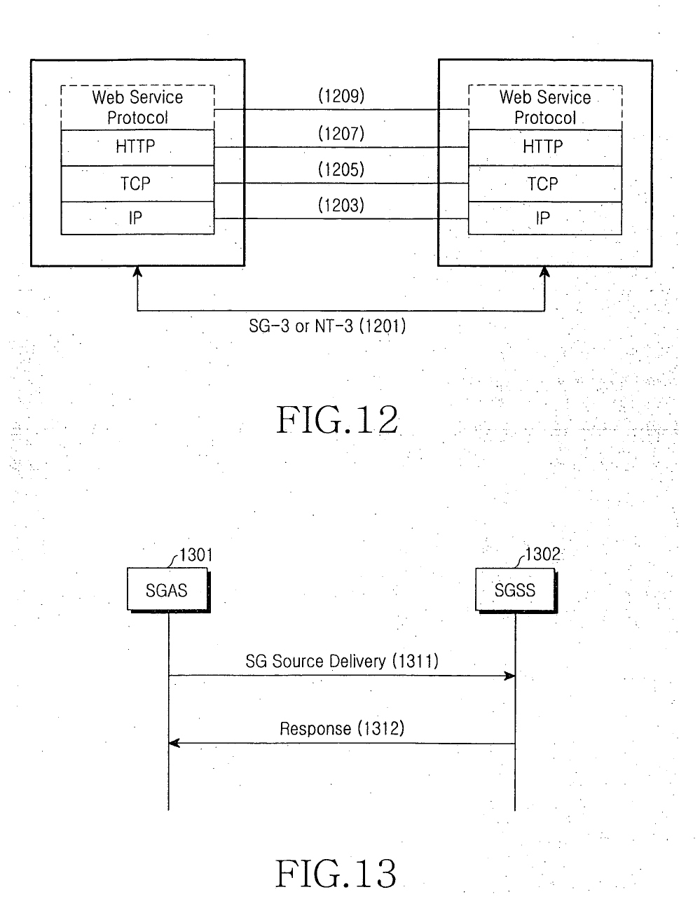

FIG. 12 is a block diagram illustrating an exemplary protocol stack used for delivering a request message for provisioning of a service guide source or a notification event over a backend interface of SG-3 or NT-3 according to an embodiment of the present invention.

For message delivery over SG-3 or NT-3 indicated by reference numeral 1201, the message can be directly delivered to HTTP using HTTP as shown in FIG. 6 or FIG. 10. As another method, the corresponding request message can be transmitted using a Web Service Protocol for XML data transmission, like Simple Object Access Protocol (SOAP), Extensible Markup Language-Remote Procedure Call (XML-RPC) and Blocks Extensible Exchange Protocol (BEEP).

Shown in FIG. 12 is a hierarchical structure formed on the SG-3 or NT-3. For communication over the SG-3 or NT-3, the same hierarchical structure preferably should be provided. Therefore, the same reference numerals are used for the same hierarchical entities in FIG. 12. That is, reference numeral 1203 shows an IP layer, reference numeral 1205 shows a TCP layer, reference numeral 1207 shows an HTTP layer, and reference numeral 1209 shows a Web Service Protocol.

FIG. 13 is a signaling diagram illustrating exemplary service guide source delivery between an SGAS and an SGSS over an SG-3 according to an embodiment of the present invention.

In step 1311, an SGAS 1301 sends information on a service guide source as shown by way of example in Table 14 to an SGSS 1302. Upon receipt of the service guide source information, the SGSS 1302 processes the service guide source information, generates a response message using the processing result, and sends the response message to the SGAS 1301 in step 1312 . The exemplary processing result message is shown by way of example in Table 15.

TABLE 14

| Name | Type | Category | Cardinality | Description | Data Type |
|---|---|---|---|---|---|
| SGSDelivery | | | | Specifies the delivery message of | |
| | | | | Service Guide Source which is used | |
| | | | | for generating Service Guide in SG-G. | |
| | | | | Contains the Following attributes: | |
| | | | | SGSDid | |
| | | | | EntityAddress | |
| | | | | Contains the following elements: | |
| | | | | SGData | |
| SGSDid | A | M | 1 | Identifier of SGSDelivery, unique in | unsignedInt |
| | | | | Network Entity which generated this | (32bits) |
| | | | | message. | |
| EntityAddress | A | M | 1 | Network Entity Address which | AnyURI |
| | | | | generates this message and receives | |
| | | | | the response. | |
| SGData | E1 | O | 0 . . . 1 | Contains information from the Content | |
| | | | | Creation to be included in the Service | |
| | | | | Guide. It is preferable that the | |
| | | | | information is delivered in the form of | |
| | | | | BCAST Service Guide fragments. | |
| | | | | Other formats can be used. | |
| | | | | If BCAST Service Guide fragments | |
| | | | | are used, network-mandatory elements | |
| | | | | or attributes which are not relevant | |
| | | | | preferably shall he delivered as empty | |
| | | | | fields, and network-optional elements | |
| | | | | or attributes which are not relevant | |
| | | | | preferably shall not be instantiated. | |
| | | | | Contains attribute: | |
| | | | | namespace | |
| namespace | A | O | 0 . . . 1 | Set to the name of the BCAST Service | AnyURI |
| | | | | Guide XML namespace to signal that | |
| | | | | the content of SGData is BCAST SG | |
| | | | | compliant. | |

TABLE 15

| Name | Type | Category | Cardinality | Description | Data Type |
|---|---|---|---|---|---|
| SGSDRes | | | | Specifies the Response message for | |
| | | | | SGSDelivery. | |
| | | | | Contains the following elements: | |
| | | | | SGSDid | |
| SGSDid | E1 | M | 1 . . . N | Identifier of SGSDelivery | unsignedInt(32 |
| | | | | Message. | bit) |
| | | | | Contains the following attributes: | |
| | | | | StatusCode | |
| StatusCode | A | M | 1 | Indicates the overall outcome of | unsignedByte |
| | | | | how SGSDelivery is processed, | |
| | | | | according to the global status code. | |

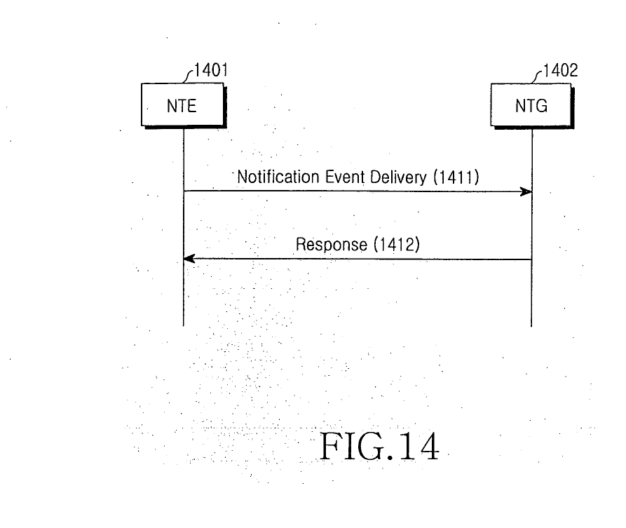

FIG. 14 is a signaling diagram illustrating exemplary notification event delivery between an NTE and NTG over an NT-3 according to an embodiment of the present invention. With reference to FIG. 14, a detailed description will now be made of notification event delivery between an NTE 1401 and an NTG 1402.

In step 1411, an NTE 1401 generates a notification event message and sends the generated notification event message to an NTG 1402. The notification event message is shown by way of example in Table 16. Upon receipt of the notification event message, the NTG 1402 processes the received notification event, generates a response signal using the processed result, and transmits the response message to the NTE 1401 in step 1412. The processed result message for the notification event is shown by way of example in Table 17.

TABLE 16

| Name | Type | Category | Cardinality | Description | Data Type |
|---|---|---|---|---|---|
| NTEReq | E | | | Specifies the delivery message of Notification | |
| | | | | Event for generating Notification Message. | |
| | | | | Contains the following attributes: | |
| | | | | NTEId | |
| | | | | EntityAddress | |
| | | | | DeliveryPriority | |
| | | | | Contains the following elements: | |
| | | | | NotificationEvent | |
| NTEId | A | M | 1 | Identifier of Notification Event. | unsignedInt |
| | | | | | (32bits) |
| EntityAddress | A | M | 1 | Network Entity Address to receive the response | AnyURI |
| | | | | of this message. | |
| DeliveryPriority | A | O | 0 . . . 1 | Defines the priority of this notification event. | Boolean |
| | | | | This information is applied to generate | |
| | | | | Notification Message in NTG. NTG can be | |
| | | | | ignored in this field. | |
| NotificationEvent | E1 | M | 1 . . . N | Specifies the Notification Event, containing | |
| | | | | information to be included in the notification | |
| | | | | message. It is preferable that the information is | |
| | | | | delivered in the form of BCAST notification | |
| | | | | message format. Other formats can be used. | |
| | | | | If BCAST notification message format is used, | |
| | | | | network-mandatory elements or attributes | |
| | | | | which are not relevant preferably shall be | |
| | | | | delivered as empty fields, and network-optional | |
| | | | | elements or attributes which are not relevant | |
| | | | | preferably shall not be instantiated. | |
| | | | | Contains attribute: | |
| | | | | Namespace | |
| Namespace | A | O | 0 . . . 1 | Set to the name of the BCAST notification | AnyURI |
| | | | | XML namespace to signal that the content of | |
| | | | | NotificationEvent is compliant with BCAST | |
| | | | | notification message format. | |

TABLE 17

| Name | Type | Category | Cardinality | Description | Data Type |
|---|---|---|---|---|---|
| NTERes | | | | Specifies the Response message for NTEReq. | |
| | | | | Contains the following elements: | |
| | | | | NTEid | |
| NTEid | E1 | M | 1 . . . N | Identifier of NTEReq Message. | unsignedInt(32bit) |
| | | | | Contains the following attributes: | |
| | | | | StatusCode | |
| StatusCode | A | M | 1 | Indicates the overall outcome of how NTEReq | unsignedByte |
| | | | | is processed, according to the global status code. | |

Exemplary codes used for indicating the result values in the response messages are shown by way of example in Table 18A to Table 18C.

TABLE 18A

| Code | Status |
|---|---|
| 000 | Success |
| | The request was processed successfully. |
| 001 | Device Authentication Failed |
| | This code indicates that the BSM was unable to authenticate the device, which may be due to |
| | the fact that the user or the device is not registered with the BSM. |
| | In this case, the user may contact the BSM and establish a contract, or get the credentials in |
| | place that are used for authentication. |
| 002 | User Authentication Failed |
| | This code indicates that the BSM was unable to authenticate the user, which may be due to the |
| | fact that the user or the device is not registered with the BSM. |
| | In this case, the user may contact the BSM and establish a contract, or get the credentials in |
| | place that are used for authentication. |
| 003 | Purchase Item Unknown |
| | This code indicates that the requested service item is unknown. This can happen e.g. if the |
| | device has a cached service guide with old information. |
| | In this case, the user may re-acquire the service guide. |
| 004 | Device Authorization Failed |
| | This code indicates that the device is not authorized to get Long-Term Key Messages from the |
| | RI, e.g. because the device certificate was revoked. |
| | In this case, the user may contact the BSM operator. |
| 005 | User Authorization Failed |
| | This code indicates that the user is not authorized to get Long-Term Key Messages from the RI, |
| | e.g. because the device certificate was revoked. |
| | In this case, the user may contact the BSM operator. |
| 006 | Device Not Registered |
| | This code indicates that the device is not registered with the RI that is used for the transaction. |
| | When this code is sent, the response message includes a registration trigger that allows the |
| | device to register. |
| | In this case, the device may automatically perform the registration, and, if the registration is |
| | successflul, re-initiate the original transaction. |
| 007 | Server Error |
| | This code indicates that there was a server error, such as a problem connecting to a remote |
| | back-end system. |
| | In such a case, the transaction may succeed if it is re-initiated later. |

TABLE 18B

| Code | Status |
|---|---|
| 008 | Mal-formed Message Error |
| | This code indicates that there has been a device malfunction, such as a mal-formed XML |
| | request. |
| | In such a case, the transaction may or may not (e.g. if there is an interoperability problem) |
| | succeed if it is re-initiated later. |
| 009 | Charging Error |
| | This code indicates that the charging step failed (e.g. agreed credit limit reached, account |
| | blocked and so forth) and therefore the requested Long-Term Key Message cannot be provided. |
| | The user may in such a case, contact the BSM operator. |
| 010 | No Subscription |
| | This code indicates that there has never been a subscription for this service item, or that the |
| | subscription for this item has terminated. |
| | The user may in such a case, issue a service request for a new subscription. |
| 011 | Operation not Permitted |
| | This code indicates that the operation that the device attempted to perform is not permitted |
| | under the contract between BSM and user. |
| | The user may in this case, contact the BSM operator and change the contract. |
| 012 | Unsupported version |
| | This code indicates that the version number specified in the request message is not supported |
| | by the network. |
| | In this case, the user may contact the BSM operator. |
| 013 | Illegal Device |
| | This code indicates that the device requesting services is not acceptable to the BSM, e.g., |
| | Blacklisted. |
| | In this case, the user may contact the BSM operator. |
| 014 | Service Area not Allowed |
| | This code indicates that the device is not allowed services in the requested area due to |
| | subscription limits |
| | In this case, the user may contact the BSM operator or subscribe to the applicable service. |
| 015 | Requested Service Unavailable |
| | This code indicates that the requested service is unavailable due to transmission problems. |
| | In this case, the request may be re-initiated at a later time. |

TABLE 18C

| Code | Status |
|---|---|
| 016 | Request already Processed |
| | This code indicates that an identical request has been previously processed. |
| | In this case, the user or the entity may check to see if the request had already been processed |
| | (i.e. received an LTK), and if not, retry the request. |
| 017 | Information Element Non-existent |
| | This code indicates that the message includes information elements not recognized because the |
| | information element identifier is not defined or it is defined but not implemented by the entity |
| | receiving the message. |
| | In this case, related entities should contact each other. |
| 018 | Unspecified |
| | This code indicates that an error has occurred which cannot be identified. |
| | In this case, related entities should contact each other. |
| 019 | Process Delayed |
| | Due to heavy load, the request is in a queue, waiting to be processed. |
| | In this case, the user or entity should wait for the transaction to complete. |
| 020 | Generation Failure |
| | This code indicates that the request information (message) could not be generated. |
| | In this case, the user or entity should retry later. |
| 021 | Information Invalid |
| | This code indicates that the information given is invalid and cannot be used by the system. |
| | In this case, the request should be rechecked and sent again. |
| 022 | Invalid Request |
| | This code indicates that the requesting key materials and messages (e.g., LTKM) are not valid |
| | and can not be fulfilled. |
| | In this case, the request should be rechecked and sent again. |
| 023 | Wrong Destination |
| | This code indicates that the destination of the message is not the intended one. |
| | In this case, the request should be rechecked and sent again. |
| 024 | Delivery of Wrong Key Information |
| | This code indicates that the delivered key information and messages (e.g., LTKM) are invalid. |
| | In this case, the request should be rechecked and sent again. |
| 025˜127 | Reserved for future uses |
| 128˜255 | Reserved for proprietary uses |

Global status codes as shown in Table 18A to Table 18C are included in a Response field of the response message. That is, when the requirements are normally processed, the Response value is set to ‘000’, and the mobile terminal can recognize from the corresponding code value that the requirements were successfully processed. Therefore, Table 18A to Table 18C should be stored in the system, or can be stored in the terminal. That is, Table 18A to Table 18C are commonly stored in the system and the terminal for future use.

Further, additional codes can be defined according to the desired purpose of the service provider. The global status codes shown in Table 18A to Table 18C can be used for the response messages associated with embodiments of the present invention, and also for all response messages for delivering the processing results in any system or terminal supporting mobile broadcast service when the results are notified using the Status codes or Response codes. Here, the Response corresponds to the Response field in the foregoing tables. For example, it can be construed as the Response field in Table 13. Therefore, the Response field of Table 13 can be used as an equivalent to the StatusCode field.

As can be understood from the foregoing description, the mobile broadcast system needs a notification event message from the NTE in the BSA to generate a notification message, and provides a method for delivering the corresponding message. For the delivered message, the NTE in the BSA should be aware of the generation result on the corresponding message, and the NTG in the BSM presents a method for generating and sending a response message for a plurality of BSAs or a plurality of event messages. In this manner, for the generation of a service guide, the SGSS in the BSM should provide provisioning information to the SG-G in the BSD/A, and can provide a method capable of previously receiving the associated service/content information.

While the invention has been shown and described with reference to certain exemplary embodiments thereof, it will be understood by those skilled in the art that various changes in form and detail may be made therein without departing from the spirit and scope of the invention as defined by the appended claims and equivalents.

What is claimed is:

1. A method for providing a service guide for a mobile broadcast (BCAST) service in a wireless communication/broadcast system supporting the BCAST service, the method comprising the steps of:
including, by a Service Guide Application Source (SGAS), service and content information in a service guide generation request message, and delivering the service guide generation request message to a Service Guide Subscription Source (SGSS) in order to provide a service guide; and
generating, by the SGSS, service guide generation and provisioning information upon receipt of the service guide generation request message, and delivering a service guide generation response message to the SGAS.

2. The method of claim 1, wherein the service guide generation request message includes SGASProvreqid indicative of an identifier of the SGAS that requested guide generation for the service and content, and BSAAddress indicative of address information of a BCAST Service Application (BSA) of the SGAS.

3. The method of claim 1, wherein the SGAS further includes schedule information in the service guide generation request message provided to the SGSS.

4. The method of claim 1, wherein the provisioning information includes PurchaseItem, PurchaseData, and PurchaseChannel information.

5. The method of claim 1, wherein the service guide generation response message is delivered using an HPPT Response message including a unique identifier for distinguishing the request message if the SGSS completes service guide generation and provisioning information generation immediately upon receipt of the service guide generation request message.

6. The method of claim 1, wherein the service guide generation response message is delivered using an HPPT POST message including a unique identifier for distinguishing the request message at a generation completion time if the SGSS does not complete service guide generation and provisioning information generation immediately upon receipt of the service guide generation request message.

7. The method of claim 1, wherein the SGSS notifies a requested result with one service guide response message upon receipt of two or more of the service guide generation request messages from the SGAS.

8. A system for providing a service guide for a mobile broadcast (BCAST) service in a wireless communication/broadcast system supporting the BCAST service, the system comprising:
a Service Guide Application Source (SGAS) for including service and content information in a service guide generation request message, and delivering the service guide generation request message to a Service Guide Subscription Source (SGSS) in order to provide a service guide; and
the SGSS for generating service guide generation and provisioning information upon receipt of the service guide generation request message, and delivering a service guide generation response message to the SGAS.

9. The system of claim 8, wherein the service guide generation request message includes SGASProvreqid indicative of an identifier of the SGAS that requested guide generation for the service and content, and BSAAddress indicative of address information of a BCAST Service Application (BSA) of the SGAS.

10. The system of claim 8, wherein the SGAS further includes schedule information in the service guide generation request message provided to the SGSS.

11. The system of claim 8, wherein the provisioning information includes PurchaseItem, PurchaseData, and PurchaseChannel information.

12. The system of claim 8, wherein the service guide generation response message is delivered using an HPPT Response message including a unique identifier for distinguishing the request message if the SGSS completes service guide generation and provisioning information generation immediately upon receipt of the service guide generation request message.

13. The system of claim 8, wherein the service guide generation response message is delivered using an HPPT POST message including a unique identifier for distinguishing the request message at a generation completion time if the SGSS does not complete service guide generation and provisioning information generation immediately upon receipt of the service guide generation request message.

14. The system of claim 8, wherein the SGSS notifies a requested result with one service guide response message upon receipt of two or more of the service guide generation request messages from the SGAS.

15. A method for providing a notification message for a mobile broadcast (BCAST) service in a wireless communication/broadcast system supporting the BCAST service, the method comprising the steps of:
sending, by a Notification Event Function (NTE) in a BCAST Service Application (BSA), a notification message generation request message for requesting generation of a notification message to a Notification Generation function (NTG) in a BCAST Subscription Management (BSM); and
generating, by the NTG, a notification message for notification information upon receipt of the notification message generation request message, and sending a result message for the generation result to the NTE.

16. The method of claim 15, wherein the notification message generation request message includes NTEid indicative of an identifier of the NTE, and BSAAddress indicative of an address of the BSA.

17. The method of claim 15, wherein the notification message generation request message includes a Notification Type filed indicating whether the notification message is to be provided to a user or to a terminal, and a Priority field indicating priority of the notification message.

18. The method of claim 17, wherein the notification message generation request message further includes a Validity field indicating valid time information of the notification message.

19. The method of claim 15, wherein the notification information represents an event occurring when there is a change in the service provided to the subscriber, when there is an upcoming change in the service provided to the subscriber, or when an emergency condition happens.

20. The method of claim 17, wherein the NTG immediately generates and delivers the result message upon receipt of the notification message generation request message from the NTE.

21. The method of claim 16, wherein the NTG generates and delivers the result message after closing a session between the NTE and the NTE upon receipt of the notification message generation request message from the NTE.

22. A system for providing a notification message for a mobile broadcast (BCAST) service in a wireless communication/broadcast system supporting the BCAST service, the system comprising:
a Notification Event Function (NTE) in a BCAST Service Application (BSA), for sending a notification message generation request message for requesting generation of a notification message to a Notification Generation function (NTG) in a BCAST Subscription Management (BSM); and
the NTG for generating a notification message for notification information upon receipt of the notification message generation request message, and sending a result message for the generation result to the NTE.

23. The system of claim 22, wherein the notification message generation request message includes NTEid indicative of an identifier of the NTE, and BSAAddress indicative of an address of the BSA.

24. The system of claim 22, wherein the notification message generation request message includes a Notification Type filed indicating whether the notification message is to be provided to a user or to a terminal, and a Priority field indicating priority of the notification message.

25. The system of claim 24, wherein the notification message generation request message further includes a Validity field indicating valid time information of the notification message.

26. The system of claim 22, wherein the notification information represents an event occurring when there is a change in the service provided to the subscriber, when there is an upcoming change in the service provided to the subscriber, or when an emergency condition happens.

27. The system of claim 22, wherein the NTG immediately generates and delivers the result message upon receipt of the notification message generation request message from the NTE.

28. The system of claim 22, wherein the NTG generates and delivers the result message after closing a session between the NTE and the NTE upon receipt of the notification message generation request message from the NTE.
